(19) United States
(12) Patent Application Publication
(10) Pub. No.: US 2017/0068984 A1
(43) Pub. Date: Mar. 9, 2017

(54) CUSTOMER REWARD SYSTEMS AND METHODS

(71) Applicant: Buzzub Inc., Saratoga, CA (US)

(72) Inventors: Sunil Pradeep Joshi, Saratoga, CA (US); Kalyan V. Krishnan, Fremont, CA (US)

(21) Appl. No.: 15/257,479

(22) Filed: Sep. 6, 2016

Related U.S. Application Data
(60) Provisional application No. 62/213,890, filed on Sep. 3, 2015.
(60) Provisional application No. 62/292,866, filed on Feb. 9, 2016.

(51) Int. Cl. G06Q 30/02; G06F 17/30; G06Q 20/36

(52) U.S. Cl. CPC G06Q 30/0226; G06Q 30/0239; G06Q 20/36; G06F 17/30867

(57) ABSTRACT

Offers are provided to consumers by a service on behalf of merchants in response to purchases by the consumer at the merchant, a collaborating merchant, or self-issued from a web site. Offers may be cloned by a consumer and provided to another user. Points may be assigned to consumers and used to purchase offers. Offers are generated with custom parameters for each customer. Offer parameters (e.g., duration, price, benefit) may be varied over time to determine successful parameters that are likely to result in offer redemption. Merchants may collaborate such that issuance of an offer for a first merchant results in issuance by the service of an offer for a second merchant. A fee may be charged by the service to the first merchant with at least a portion of the fee being paid to the second merchant.

### RELATED APPLICATION

This application claims the priority benefit of U.S. Provisional Application Ser. No. 62/213,890, entitled “GAMIFIED, COLLABORATIVE INCENTIVE MECHANISMS FOR SMALL BUSINESSES TO INCREASE CONSUMER SHIPPING,” filed Sep. 3, 2015, the disclosure of which is incorporated by reference herein in its entirety.

This application also claims the priority benefit of U.S. Provisional Application Ser. No. 62/292,866, entitled “TECHNIQUES AND MECHANISMS TO INCREASE DISTRIBUTION AND EFFECTIVENESS OF DIGITAL COUPONS FOR SMALL BUSINESSES”, filed Feb. 9, 2016, the disclosure of which is incorporated by reference herein in its entirety.

### TECHNICAL FIELD

The present disclosure relates to systems and methods that implement, for example, customer reward programs offered by merchants offering goods or services for sale.

### BACKGROUND

Larger businesses have reasonably sophisticated systems that collect transactional and other browsing information via POS systems and online presence for their consumers so that this CRM data can be analyzed to send targeted ads to consumers to help increase their spending. In contrast, smaller businesses (“mom & pop”) and some medium sized businesses generally referred to as SMBs, do not have capabilities anywhere close to these. SMBs typically resort to traditional print media advertising and paper couponing to get consumers to shop with them. Often, the coupons have an expiration date to encourage the consumer to shop before the sale ends. Some SMBs use punch cards to encourage repeat visits as a form of loyalty to get repeat business. Recently, some SMBs are starting to use mobile apps for advertising their discount offers and also for keeping track of punch card punches. However, the capability that SMBs don't have prior to this invention is to incentivize a specific consumer with a specific offer (of discount or other enticement) to return back to the merchant within a specific time period, all of which are customized for each consumer based on his/her shopping patterns and are gamified to incentivize the consumer to shop more (increase spend per visit, visit frequency, and number of visits). This invention describes the technology and mechanisms that enable SMBs to provide these capabilities.

In addition to the above mechanism for a merchant to increase business with his own consumers, the invention describes novel mechanisms for merchants to i) leverage their consumers, and ii) leverage other merchants, to dramatically increase their own reach and sales. The effect of these leverages is amplified due to network effects, creating an entirely new dynamic in the marketplace.

The systems and methods disclosed herein provide a system facilitating increase of sales by small- and medium-sized businesses.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a network environment in accordance with an embodiment of the present invention.

FIG. 2 is a process flow diagram of a method for providing an initial offer to a consumer in accordance with an embodiment of the present invention.

FIG. 3 is a process flow diagram of a method for providing an offer to a return consumer in accordance with an embodiment of the present invention.

FIG. 4 is a process flow diagram of a method for generating offers according to various criteria in accordance with an embodiment of the present invention.

FIG. 5 is a process flow diagram of a method for adjusting offer parameters over time in accordance with an embodiment of the present invention.

FIG. 6 is a schematic block diagram of a system for generating offers in accordance with an embodiment of the present invention.

FIGS. 7 and 8 are example interfaces to a merchant application in accordance with an embodiment of the present invention.

FIG. 9A is a process flow diagram of a method for varying offer parameters over time in accordance with an embodiment of the present invention.

FIG. 9B is a schematic diagram illustrating feedback used to generate offers in accordance with an embodiment of the present invention.

FIG. 10 is an example interface to the merchant application showing offer statistics in accordance with an embodiment of the present invention.

FIG. 11 is a schematic block diagram of a collaborative environment in accordance with an embodiment of the present invention.

FIG. 12 is a process flow diagram of a method for cloning offers in accordance with an embodiment of the present invention.

FIG. 13 is a process flow diagram of a method for generating collaborative offers in accordance with an embodiment of the present invention.

FIG. 14 is an example interface for self-issuing offers in accordance with an embodiment of the present invention;

FIG. 15 is a schematic block diagram of a system for enabling the purchasing of offers using points in accordance with an embodiment of the present invention;

FIG. 16 is a process flow diagram of a method for enabling the assignment of points and the purchasing of offers using points in accordance with an embodiment of the present invention; and

FIG. 17 is a block diagram that depicts a generalized processing architecture that can be used to implement the routing system and other systems and components discussed herein.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein describe a customer reward program. The rewards offered to a customer include, but are not limited to rewards such as cash back and points-based rewards. Some embodiments implement the customer reward program via methods that include application software running on one or more computing devices that include, but are not limited to laptop computers, desktop computers, mobile devices, tablet computers, or any combination of processing devices capable of connecting to a public network such as the Internet. Any combination of these computing devices may be in used by the customer or the merchant as a part of the customer reward program. In other embodiments, the implementation of the customer reward program is done independently of and without any interaction with the merchant point-of-sale device. Some embodiments of the systems and methods described herein use a cloud-based computing architecture that includes a server and a database, to implement at least a portion of the customer reward program architecture.

Operating Environment

Novel rewards mechanisms for consumers and merchants are described herein. In particular, new mechanisms are disclosed for providing rebates or cash-back that are tailored to suit differing business needs.

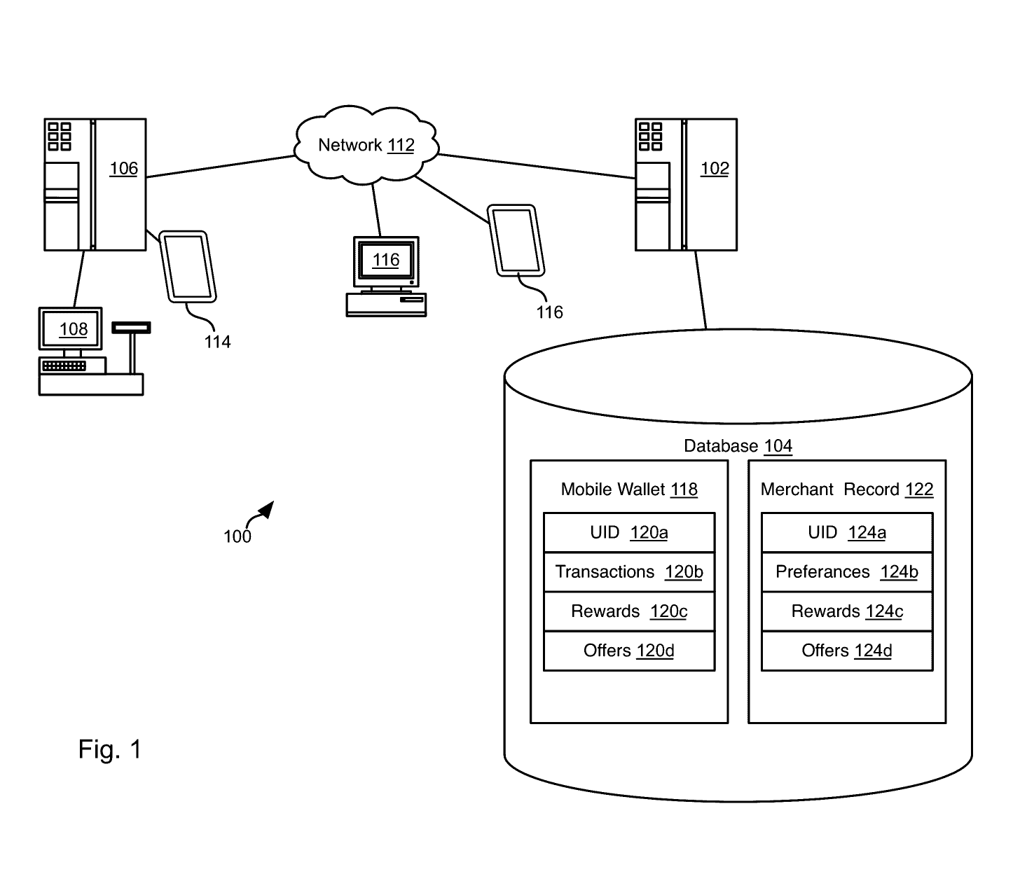

Referring to FIG. 1, the following entities may interoperate to implement an operating environment 100 for implementing the methods disclosed herein:
Cloud/SaaS: Cloud-based Software-as-a-Service (SaaS) which can be accessed via a multitude of devices including Mobile devices such as smart phones and tablets, as well as desktop computers via web browsers. The systems and methods disclosed herein may be accessible via this approach in some embodiments. For example, a server system 102 may implement the service disclosed herein, such as in the form of a cloud-based SaaS. The server system 102 may host or access a database 104 storing various data structures described below for implementing embodiments disclosed herein.
SaaS Cloud Service: This is also referred to in the document as Cloud Service or just Service. This is the SaaS service in the cloud that consumers and merchants connect to and which holds the data and the logic for processing transactions according to logic described herein. The service may be executed by the serve system 102 in combination with the database 104.
Merchants: Retail stores/shops (with a physical store front or web-based businesses) where customers can buy goods/services. A merchant may use or operate a server system 106 to manage inventory, process transactions, and provide other functions for managing a retail store.
POS: Point of sale terminal or system 108. Compared to just a cash-register or a calculator, POS 108 are typically more sophisticated, usually networked via a network, such as a network 112 including a local area network, wide area network, the Internet 112, or any other wired or wireless network connection. For example, the POS may be connected to the server 106 or other cloud-based service such as the server 102. The POS 108 may be a computing device having numerous additional features over and above the basic transaction processing.
Merchant appliance: The merchant appliance 114 is an electronic device that a merchant uses for reward and incentive transactions for the consumer. In the simplest case, it is a merchant application for a mobile device 114, e.g., smartphone, which converts the phone 114 into a dedicated device that securely connects to the server 102 over the network 112 and allows the processing of reward/incentive transactions. It is also possible for the merchant to simply download the merchant application onto a supported mobile phone 114 (or phablet) to convert the device into a merchant appliance.
Merchant application: This is a mobile application that runs on the merchant appliance 114 and allows the merchant to administer and transact rewards and incentives according to the methods disclosed herein.
Customers: Individuals who shop for goods and services from retail merchants. Customers are also referred to as “consumers” in the following disclosure. A customer may interact with the server 102 or one or more computers 106, 108, 114 of a merchant by means of a computing device 116, such as a desktop or laptop computer, mobile phone, tablet computer, or other computing device 116.
Mobile Wallet: The mobile wallet 116 may be stored in the database 104 and be uniquely associated with a particular customer, such as by means of a unique user identifier (UID) 120a. The mobile wallet 116 may store records of previous transactions 120b of the customer with the merchant or this data may be stored in a separate record that may be related to the customer's UID 120a. The mobile wallet 118 may also store rewards 120c, offers 120d, and any other incentives assigned to the customer according to the methods disclosed herein. The mobile wallet 102 may be maintained by the service executing on the server 102. Cash-backs and rebates are deposited to the mobile wallet 118 as rewards 120c, and if part of that money is used as payment for a purchase or withdrawn in some way, it is debited from the rewards 120c of the mobile wallet 118. The offers 120d may also include coupons with assorted deals, offers, and/or discounts from merchants, potentially with expiration dates.
Customer Application: This is a mobile application that runs on a consumer's computing device 116 that gives the customer the ability to administer the consumer's account and also to find advertised offers and rewards.
Rewards: This term is used rather broadly in this document. A reward can be given in recognition for shopping and purchasing or it can also be an incentive given to a consumer by the merchant to come back and shop again. The incentive can be in the form of a discount coupon or a rebate coupon or some offer which makes it attractive to shop at the store.
SMB: Small and Medium Businesses. This is a broad range of businesses ranging from home based businesses to mom and pop businesses to even family owned chain-stores and some less centralized franchises. SMBs may or may not have a retail outlet, and some may only have an online presence. Some may sell products while others may offer services.
Merchant Account: Each merchant, e.g., SMB, using the service may have a merchant record 122 or account 122 associated with it and storing information relating to the merchant in the database 104. The merchant record 122 may be associating with a UID 124a uniquely identifying the merchant and include preferences 124b governing how rewards and incentives (e.g., offers such as coupons) are generated according to the methods described herein. The merchant record 122 may additionally store information regarding rewards 124c and offers 124d provided by the merchant to consumers. Alternatively, this data 124c-124e may be omitted since it will also be stored in the mobile wallets 118 of the consumers.

Prior Approaches

Large Retailers with POS systems (e.g., CVS) can print a receipt with several ads at the end of it. Some of these ads are coupons with discounts with barcodes that can be scanned when redeemed. The coupons may have an expiration date. The ads and/or coupons printed at the end of the receipt may be different for each consumer and may depend on what the consumer purchased.

SMBs typically use print advertisements in newspapers, inserts, flyers, and postal mail coupons (e.g., Valpak). The advertisements typically include a deal or other offer. Some of these may be coupons that can be cut out. These may have expiration dates. Everyone in a neighborhood typically gets the same set of offers, e.g., coupons, as these are not customized per consumer. Coupons are not individually trackable, but it may be possible to tell if they came from postal-mail or via a newspaper based on a code printed on each coupon.

Some POS systems may allow the SMB to print coupons along with receipts. Printing of the coupon may be conditioned on the purchase amount exceeding a threshold. Some software packages allow more complex coupon printing. Some POS systems permit SMB POS Coupons in digital form. These are similar to printed coupons, but can be emailed to the consumer.

Some businesses (e.g., restaurants) may give the consumer a paper coupon, with an expiration date to use the next time they visit the store. Some businesses may give a punch or a stamp on a card so that once a certain number of punches are collected they can receive something for free. Punch cards often don't have expiration dates, but some may. Instead of a physical, paper punch card, some businesses have a mobile application that the consumers use. These applications effectively keep track of the punches on the mobile phone. Usually, the punches don't have expiration dates.

### DESCRIPTION OF DISCLOSED EMBODIMENTS

In case of an SMB that does not have a POS system with the ability print or email coupons, there is no mechanism available to make offers, e.g., digital coupons, available. Such SMBS do not have the ability to print coupons and offers with expiration dates and that are individually tailored for each consumer by identifying the consumer, and looking at the current and past shopping pattern of each consumer. Additionally, there is no mechanism available for the merchant to tailor the offer, e.g., coupon, with any sophistication including adaptive learning that results in gamification that produces measurable increased purchases from the consumer.

The systems and methods disclosed herein provide this functionality to SMBs. The systems and methods disclosed herein advantageously incentivize the consumer to return back to the merchant within a specified amount of time in order to be able to take advantage of a special offer, e.g., coupon, being given to the consumer.

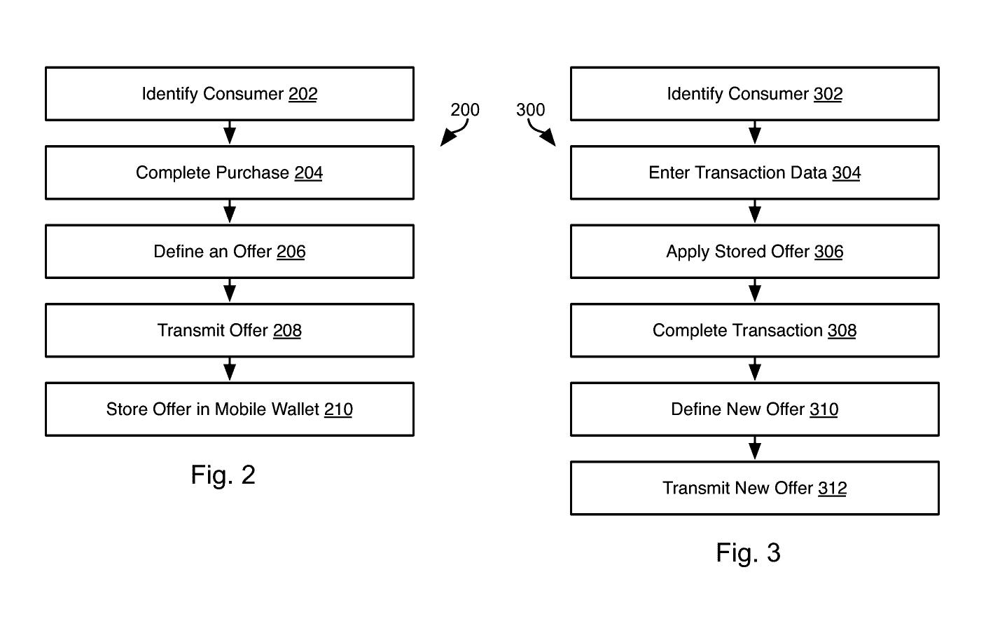

FIG. 2 illustrates a method for providing an offer to a customer. The method 200 may be performed by a merchant that may or may not have a POS 108, but does not have the capability to issue any digital form of coupons. The method 200 may be performed using a merchant appliance 114, which runs the merchant application. The steps of the method 200 outline what happens when a consumer shops at the merchant for the first time:

The method 200 includes identifying 202 the consumer, such as by entering the consumer's mobile phone number into the merchant application and transmitting this to the server system 102. Where this is the first transaction of the consumer with the merchant, there are no offers 120d in the mobile wallet 118 of the consumer from the merchant. Accordingly, no offers will be shown in the merchant application as being available to the consumer.

The method 200 further includes completing 204 a purchase with the consumer, i.e. the consumer buys goods or services from the merchant and pays for them in the conventional manner.

The merchant may then invoke defining 206 of an offer for the consumer based on the completed 204 transaction. This may include defining a “See You Soon” (or SYS) offer. For example, the merchant presses a button on the merchant application that gives the consumer a See You Soon Coupon offer. This offer may be transmitted 208 to the consumer by a text/SMS message or may be sent via email or via push notification to the consumer application executing on the consumer computing device 116. If the consumer is new to the service, the extension of the offer automatically enrolls the consumer in the rewards program database, e.g., a mobile wallet 118 is created for the consumer. The offer may also be stored 210 in the mobile wallet 118 of the consumer.

The offer is called “See You Soon” as it is inviting/incentivizing the consumer to come back to the store within a certain time period in order to receive some benefit. The implication is that this sweet deal will not be available after the offer expiration date. A typical format for the offer can be of the form:

“See You Soon in 3 days or less to receive a free drink with your meal.”

The underlined items can vary depending on the business and their offerings. In other words, the general format is:

“See You Soon in valid-duration> to receive <a special benefit to shop with us>” or

See You Soon in <T duration> to receive <a B benefit for a P purchase-value>” or

See You Soon <on or before T date> to receive <a B benefit for a P purchase-value>”

For simplicity, later, these are represented in the format: S:[T;P;B].

The variable T shown above is shown for simplicity to either mean duration or date, as this is decipherable based on context. Two situations are now possible—the consumer may return within the valid-duration, or may miss the time window and come in late. If the consumer misses the time window, then once again the merchant may repeat the steps of the method 200 as if this was a first time consumer, and offer the customer a new offer, e.g., coupon, to return, but without providing any special benefit for this visit. If the consumer returns within the valid-time before offer expiration, the method 300 of FIG. 3 may be executed.

Referring to FIG. 3, for a transaction occurring prior to expiration of any previous offers, the illustrated method 300 may be executed. The method 300 may include identifying 302 the consumer in the same manner as for the method 200, e.g., by entering the consumer's mobile phone number in the merchant application. The offers 120d issued by the merchant to the consumer may be retrieved. If the offer has not expired, the merchant application may display that a valid offer from the merchant is available to the consumer.

The method 300 may include entering 304 transaction data, e.g., the identifiers for products or services purchased. The stored offer that has not expired may be applied 306 to the transaction. The consumer then completes 308 the transaction, i.e. the consumer buys the goods or services from the merchant and pays for them has he/she normally does. Applying 306 the stored offer may include providing either promised free goods/services as per the offer, e.g., a coupon, or a discount defined by the offer such that the purchase price for the items of the transactions is reduced.

The method 300 may further include defining 310 a new offer and transmitting 312 the new offer in the same manner as for steps 208, 210 of the method 200 based on the transaction completed at step 308. For example, the merchant may press a button in the merchant application that gives the consumer a new See You Soon offer. The service automatically records in the offers 120d of the consumer's mobile wallet 118 that the previous SYS offer is redeemed and records the new offer in the offers 120d. This starts a countdown until expiration of the new offer.

The capability to issue a time-bound (See You Soon) coupon offer in a digital way, using a merchant appliance 114 that is independent of and disconnected from the POS 108 does not exist in the marketplace currently.

The method 200 illustrates a simple form of using a merchant appliance 114 and an associated merchant application for incentivizing a consumer with a time-bound offer, e.g., coupon, that is an incentive to purchase something with a benefit associated with that purchase. There are only two variables defining the offers in the example of FIGS. 2 and 3: i) valid duration, and ii) incentive benefit. This is the simplest case of a broader solution provided by the approach describes herein, which attracts consumers for return visits and incentives them to spend more. A general, broader implementation may include more variables.

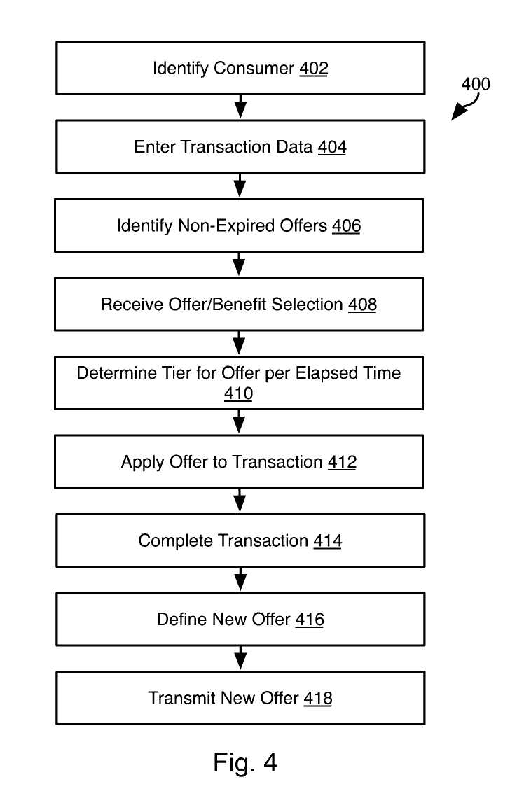

For example, a transaction including redemption of an offer and providing a new offer may include some or all of the steps of the method 400 of FIG. 4. The method 400 may include identifying 402 the consumer participating in a transaction and entering 404 transaction data in the same manner as for the method 300.

The method 400 may include identifying 406 one or more non-expired offers. As noted above, each offer may have an expiration date. Accordingly step 406 may include determining offers for which the expiration date is in the future. In some embodiments, offers may have multiple tiers of benefits and multiple durations t1, t2, t3, e.g. each tier of the offer may have a different duration with the most desirable having the shortest duration. Accordingly, these durations of one or more offers 120d in the consumer's mobile wallet 118 may be evaluated to determine which tier of each offer has not yet expired.

In some embodiments, an offer may include a plurality of offer options, e.g., different products or services and different deal parameters. Likewise, there may be multiple unexpired offers. Accordingly, the method 400 may include receiving 408 user selection of an offer or option for a particular offer. For example, the user may provide a selection to the merchant for input to merchant appliance 114 or provide the selection through the consumer application executing on the customer application executing on the consumer computing device 116.

The method 400 may further include determining 410 a tier for the selected offer. In some embodiments, instead of a single duration for a benefit, there could be a series of durations (t1, t2, t3 etc.) with different, lesser benefits (b1, b2, b3 etc.) associated with each time window. This way an offer does not completely expire, but gets less beneficial and still may provide some token benefit for those who are late. Accordingly, for the selected offer, the benefit bn based on the shortest unexpired duration to may be determined 410.

The method 400 may then include applying 412 the benefit determined at step 410 to the transaction and completing 414 the transaction in the same manner as for the method 300.

The method 400 may further include defining 416 a new offer. The new offer may then be transmitted 418 to the consumer in the same manner as for the method 300 and stored in the mobile wallet 118 of the consumer.

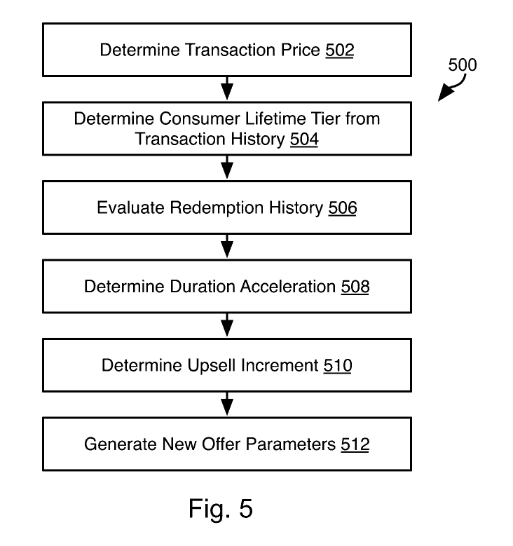

Referring to FIG. 5, in some embodiments, defining 416 the new offer may include executing the illustrated method 500. In particular, various variables may be evaluated to determine an offer, i.e. a product or service or a category of products or services to include in an offer and the value of the offer, e.g., discount amount or number of items available at the discount amount.

For example, the method 500 may include determining 502 a transaction price, e.g., the total purchase price of the transaction for which the offer is a reward.

The method 500 may further include determining 504 a consumer lifetime tier based on the transaction history. The lifetime tier of the consumer may be recorded in the database 104 and be retrieved at step 504 or may be computed or updated at step 504. The customer lifetime tier represents a value of the customer to the merchant over time or over a recent time window, e.g., last six months or year. The customer lifetime tier may be a function of the sum of the total purchase prices of all transactions of the consumer or all transactions during the recent time window. The customer lifetime tier may be a function of the profit to the merchant as a result of all transactions of the consumer or all transactions during the recent time window.

In some embodiments, the customer may be assigned to a particular tier of a discrete number of tiers based on the sum of purchase prices or total profit from the customer computed as outlined above. For example, each consumer assigned to a particular tier may have a sum of purchase prices or total profit lying in a unique range of values corresponding to the particular tier.

The method 500 may include evaluating 506 a redemption history of the consumer. Specifically, for each offer provided to the consumer according to the methods disclosed herein whether or not the offer was redeemed may be the consumer. Attributes of the offers that are redeemed may be aggregated and/or attributes of the offers that are not redeemed may be aggregated. Aggregated attributes may include a list of product or category of products of the aggregated offers, an average purchase price of the aggregated offers, a statistical value (mean, standard deviation, 25^{Th} percentile, etc.) of the purchase prices of the aggregated offers.

The method 500 may further include determining adjustments based on an experimental evaluation of the consumer over time. For example, attributes of offers may be adjusted over time in order to determine effective attributes of an offer that will entice the consumer to redeem the offer.

For example, the method 500 may include determining 508 a duration acceleration for the offer according to a sequence of decreasing durations. For example, a first offer may have a first duration t1 before expiration, a second offer a duration t2, and so on, with the durations decreasing. The durations below which the consumer no longer redeems offers may then be identified.

The method 500 may include determining 510 an upsell increment. If the merchant's goal is to get a consumer to spend more, the other approach is to get the consumer to spend more by gradually offering coupons that apply to higher and higher amounts of spending (referred to here as upsell), mostly likely with higher degrees of benefits, to see at what point the consumer gives up or does not find them interesting. Accordingly, the price of the product or class of product that is the subject of the offer may be selected according to a price based on a current value of an upsell sequence that is incremented 510 with each offer provided to the customer.

The method 500 may include generating 512 a new offer based on the values obtained at steps 502-510. Specifically, the value of the offer, e.g., of a discount or free product, may be determined according to a function that increases with the transaction price of step 502 and the customer lifetime tier of step 504. The product may be selected to be a class of products for which the customer has a high probability of redeeming according to the redemption history of step 506. The product may also be selected as having a purchase price corresponding to the current value in the upsell sequence from step 510. The expiration date of the offer may be selected according to the duration of step 508.

The offer as determined according to the method 500 may then be processed according to the methods described in FIG. 3 or 4.

Parameters, rules, and logic for generating offers according to the above-referenced parameters may be specified in the preferences 124b of the merchant.

In some embodiments, instead of giving just one award per visit, the consumer may get multiple offers, e.g., coupons, at once (each with different durations and benefits) to allow the consumer choice and flexibility. Each offer may be selected and defined according to the method 500, e.g., have some or all of the attributes determined according to the method 500.

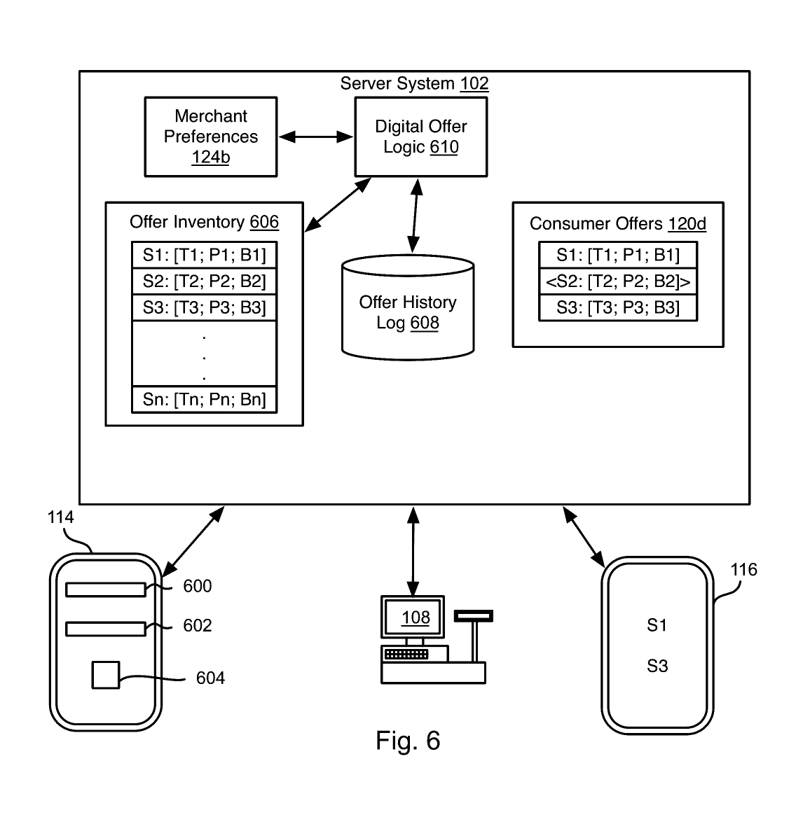

Referring to FIG. 6, the service described herein runs in the cloud, which is represented here by the server system 102. The merchant application executes on the merchant appliance 114 and connects to the server system 102 through a network connection, which may include a mobile connection (Internet, 3G/LTE, SMS, etc.). Likewise, the consumer application executing on the consumer computing device 116 also connects to the server system 102. If the consumer does not have an app, the consumer computing device may connect to the server system 102 by means of the Internet or SMS. The merchant application is used for providing offers, e.g., coupons, to consumers and also for noting which offer has been redeemed. For example, the merchant application may define an input field for a consumer identifier 600 of the consumer, a listing 602 of one or more offers provided to the consumer, and a button 604, i.e. a “See You Soon” (SYS) button 604, that, when selected, invokes providing of an offer to the consumer according to the methods disclosed herein The consumer application displays the offers (S1, S3) that were sent to the consumer.

The merchant appliance 114 is not necessarily connected to the Merchant's POS 108. It can be an independent or standalone device. The merchant application may implement various functions for setup and maintenance. During operation, in its simplest form, it may only have only one field 600 to record a consumer ID, and just one button 604, the SYS button, that authorizes the giving of an offer, e.g., a SYS Coupon. For situations where consumers have multiple offers of which they select one to use, there could be an additional selection field 602 for selecting which coupon is being redeemed.

The consumer application, if present on the consumer computing device 116, may display the list of currently active offers (S1, S2). Optionally, it can show an offer history as well, e.g., a listing of offers and a redemption status for each (e.g., redeemed, expired, non-expired and not redeemed, etc.). In the absence of the consumer application, the consumer computing device 116 can show a received offer as a text message. A consumer can also access use a link provided in a text message or other type of message to retrieve a web page including offer information.

The service may maintain all of the state information for all transactions. For example, the service may maintain an offer inventory 606 for each merchant that is a complete list of all the offers the merchant may have available to offer to consumers.

The service may store and access merchant preferences 124b that are a set of rules set by the merchant that specify which offers are allowed to be given under what conditions (for example, a high discount coupon may only be available to a consumer that does high value purchases). The preferences 124b may, for example, specify the generation of offers based on the values evaluated according to the method 500.

The service may store and access the consumer offers 120d of each consumer that may be embodied as a current and historical list of all the offers that a specific consumer has received. Offers that are current or expired can be listed in the offers 120d. In practice, a consumer that shops at multiple stores may have multiple offers from different merchants in the consumer offers 120d. These offers may be listed in some order, such as date of expiration or importance of merchant etc.

The service may store and access an offer history log 608. Each time a coupon is given out or redeemed, the service keeps track of this, as this is communicated to the service by the merchant application. Some or all of the history of which coupons were awarded, expired or redeemed by a particular consumer may be available in the offer history log 608.

Digital offer logic 610 takes available inputs (offer inventory 606, merchant preferences 124b, and offer history log) and suggests an offer for the consumer with the aim to incentivize the consumer to shop repeatedly and often with higher value purchases while minimizing the margin loss for the merchant that can happen due to over-discounting when not needed. For example, the inputs may be processed according to the method 500 of FIG. 5 to generate an offer or any of the methods disclosed herein.

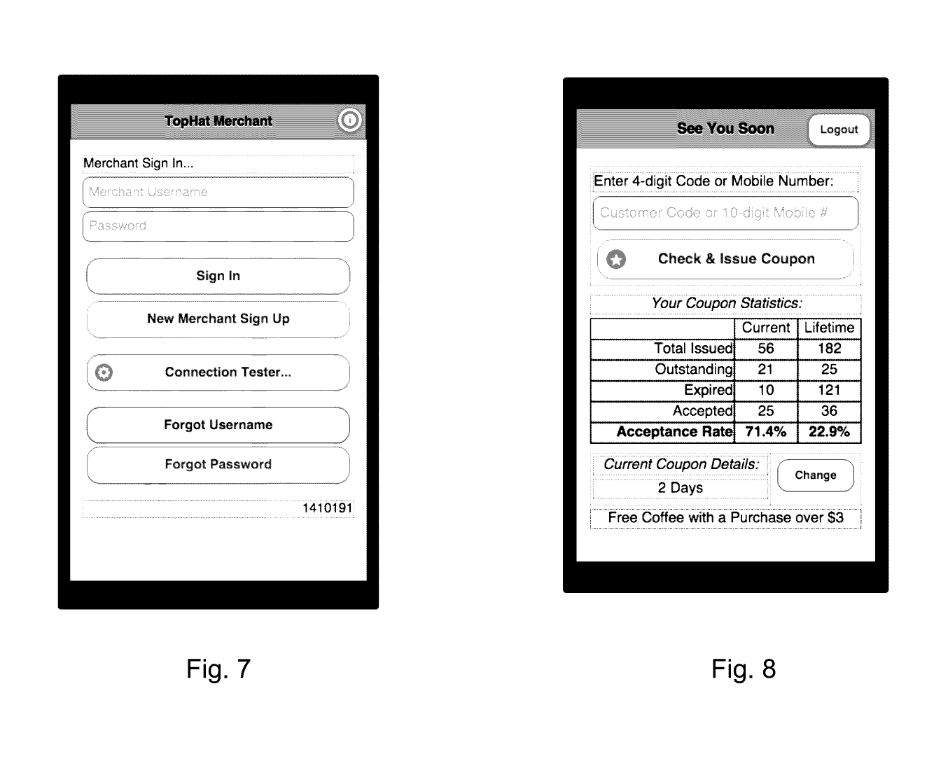

FIG. 7 illustrates an example login screen. If a merchant is new, the “New Merchant Sign-up” may be selected to invoke presentation of an interface enabling inputting of the merchant's credentials and registering. Once registered, the merchant is given a username and password, which can be used to log in to the app. Of course, there can be buttons to retrieve a lost/forgotten username or password. The example of FIG. 7 further includes a “Connection Tester” button that, when selected, invokes checking network connectivity to the merchant appliance 114 to ensure that the connection from the merchant appliance 114 to the server system 102 is working as intended.

FIG. 8 illustrates the post-login operational screen for an example embodiment of a merchant application. In the illustrated example, only one offer is being considered. In this case, only a field for entering the Consumer ID is needed along with one button that invokes issuance of an offer to that consumer ID (“Check & Issue Coupon”). This button also referred to as the “See You Soon,” button serves two purposes. When clicked, it checks the status of the offer for the consumer, if any, and informs the Merchant whether it is valid or not. If valid, the Merchant can provide the promised discount. In the same step, it also issues a new offer for the next visit. Hence it is labeled here as “Check & Issue Coupon.” As is readily apparent, the interface of FIG. 8 facilitates execution of the method 300 or the method 400.

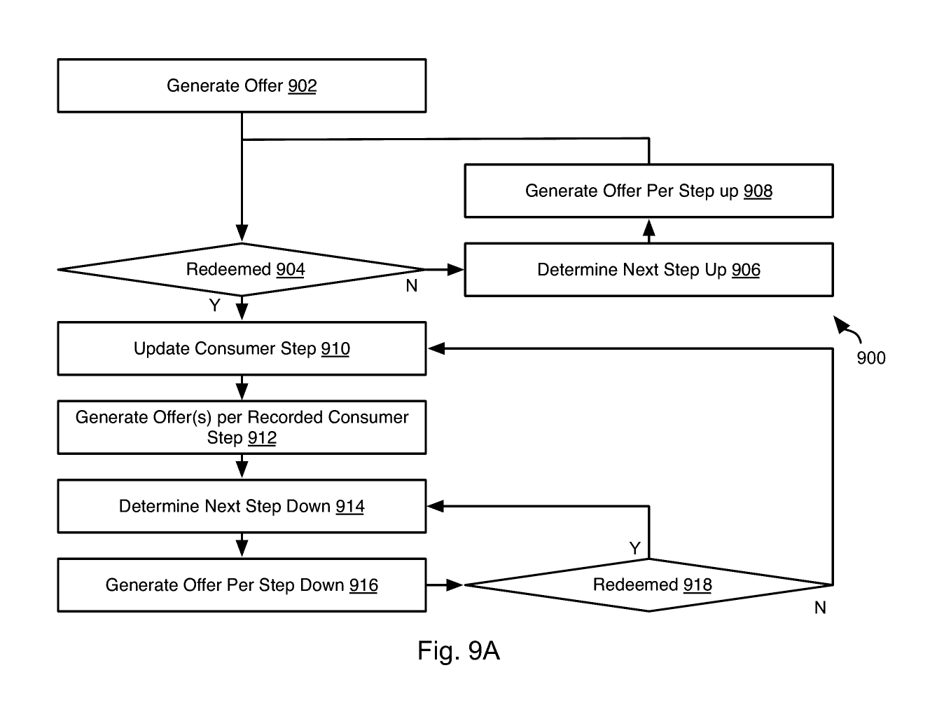

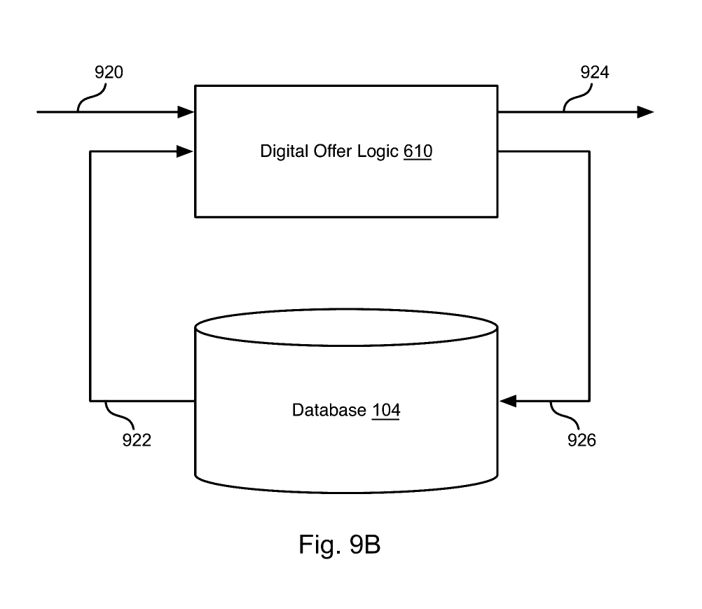

Referring to FIG. 9A, a merchant's goal is to increase sales revenue while also maintaining or increasing margins. Consumers on the other hand look for great deals, which save them money or give them higher value. If the deal is not good enough, the customer may walk away from it. The sweeter the deal for the consumer, the worse it may be for the merchant, especially from a margin perspective, but if consumers like the deal, it may increase the revenue. So, in this tradeoff of increasing sales revenue versus increasing margins, the merchant is often seeking an optimum point, or at least the best point where he does not over or under-discount his goods or services.

There are essentially three main variables that the digital offer logic 610 has to work with to iteratively find the optimum point for each offer that has a good chance of success from a statistical basis. These three variables (T, P and B) are part of the coupon offer statement: “See You Soon in <duration (T)> to receive <a benefit (B) for a purchase-value (P)>.” Each of these can affect behavior and outcomes. A shorter duration (T) increases sales for a merchant, but pressures the consumer to shop soon. A higher purchase value (P) increases sales for a merchant, but costs more for the consumer. A higher benefit (B) reduces merchant's margin, but provides higher value for the consumer. It should be noted that P and B may be expressed in many different forms. They can be offered in the form of discounts ($s, % or BOGO-style i.e. buy-one-get-one etc.), cash-back rebates, points, free stuff, or service offers. Sometimes the value of P may not be obvious or noted.

These variables can have many different values on a continuum, but for simplicity, for illustration purposes, if we were to just show them with Low (L) and High (H) values and see if the effect of different combinations of these variables, it becomes clear that some of these benefit the merchant (M) and others the consumer (C) (see Table 1, below). A sequence is shown which indicates eight permutations ordered such that the choices become increasingly more favorable to the consumer moving down from the first line of Table 1 where they are the most favorable to the merchant. For example, in the first line Table 1, the consumer is given less time to buy a high purchase price item for a low discount, so this combination clearly favors the merchant. Different permutations of the ordering may be made and adjustments to the Low and High values may be made to provide a desired step up for each permutation in the ordered listing. In some instances, a merchant may have multiple offers that correspond to several of these categories in the offer inventory 606 for the digital offer logic 610 to choose from. It is not necessary that all combinations have a choice provided, but they can be ranked by the merchant based on the merchant's preference, e.g., increased sales or increased margins.

TABLE 1
Step-Up Sequence

| | | | | | Sequence |
|---|---|---|---|---|---|
| | | | | | (Least |
| | | | | | interesting |
| | | | | | to Most |
| | P | | | Who Benefits | interesting |
| T | (Purch. | B | | (M = Merchant; | to |
| (Duration) | Value) | (Benefit) | Consumer Perception | C = Consumer) | Consumer) |
| L | L | L | High pressure, not enticing | M | 3 |
| L | L | H | High pressure, but enticing | M, C | 7 |
| L | H | L | High pressure, not enticing | M | 1 |
| | | | at all! | | |
| L | H | H | High pressure, enticing | M, C | 5 |
| H | L | L | Not very enticing | M | 4 |
| H | L | H | Low pressure, very | C | 8 |
| | | | enticing | | |
| H | H | L | Not very enticing | M | 2 |
| H | H | H | Low pressure, enticing | M, C | 6 |

Table 1 provides an example ordering of offers based on benefit to the consumer that provides the basis for the gamification strategy of the method 900 of FIG. 9. However, any other ordering of offer attributes may be used according to the method 900 to identify offer attributes that increase the value to the merchant while still appealing to the consumer sufficiently to induce the consumer to redeem the offer.

The method 900 may include generating 902 an offer. The offer may have the attributes corresponding to the entry of the first line in Table 1, i.e. the most favorable to the merchant. Generating the offer and providing it to the consumer at step 902 may include executing any of the methods 200, 300, and 400.

If the offer is found 904 not to have been redeemed, the method 900 may include determining 906 a next step in the sequence, line 2 of Table 1 in the illustrated example, and generating 908 an offer according to the next step. If this offer is found 904 not to have been redeemed, steps 906 and 908 are repeated. If an offer is found 904 to have been redeemed, a record for the consumer may be updated 910 to indicate that the attributes of the step corresponding to the offer (“the successful step”) have a high probability of appealing to the consumer. Subsequent offers may then be generated 912 that have these attributes, or a range of attributes including the attributes of the successful step.

In some embodiments, after a successful step is identified, the method 900 may include attempting to move to a lower step (less appealing to the consumer) to determine whether an offer is redeemed. When determining the appeal of a lower step the Low and High values may be the same or different from those used to identify the successful step stored at step 910. In particular, the Low values may be more appealing to the consumer than the Low values used in steps 902-908, but less appealing than the High values of the successful step.

The method 900 may include determining 914 a next step down from the successful step and generating 916 an offer having the attributes of the next step down. If the offer is found 918 to have been redeemed, the next step down becomes the successful step and steps 914-918 are repeated. If the offer is not redeemed, then the consumer profile is updated 910 to indicate that the last successful step is likely to result in redemption of the offer and one or more offers are generated 912 as outlined above. Note that step 912 may include generating multiple offers, e.g., from two to ten offers, before the possibility of a step down is determined according to steps 914-918.

Various modifications of the approach of FIG. 9 may be used in order to determine offer attributes that are favorable to the merchant and are likely to be redeemed by the consumer. For example, rather than a sequential approach wherein each step is more favorable than the next, or less favorable then the next for steps 914-918, a binary search approach may be used. For example, there is a possibility that the consumer may never return after the first coupon offer that is not redeemed and hence there is no chance to try the next step. The binary search on the other hand starts with the middle step of the sequence (say line four or five of Table 1, preferably five) to at least make the first offer interesting enough for the Consumer to consider. If it works, then the next offer could be at a lower step (e.g., line three of Table 1) to see if that too would work. If not, an offer at a higher step (e.g., line six of Table 1) could be provided if the consumer does return at some future point after the coupon expiration.

Various other orderings of steps in the sequence and various search algorithms as known in the art may be used to determine a good step for a particular consumer or group of consumers. The above two were selected to show that interesting approaches exist to entice consumers to shop more, and more often.

The digital offer logic 610 described herein allows a very simple process at the merchant level using the merchant application (e.g., enter Consumer ID and click on the SYS button 604) that results in a very sophisticated, redemption history based, adaptive learning approach to iteratively select the next coupon to offer to any specific consumer, such that the revenue and margin gain to a merchant is increased closer to a maximum on a statistical basis.

In addition, although the method of FIG. 9 is shown with respect to a single customer, multi-consumer heuristics may also be used to identify a set of offer attributes having a high likelihood of success and a high benefit to a merchant. Specifically, heuristics may be developed across multiple consumers' behaviors to predict what an average consumer will do (i.e. what offers will be liked the first time around etc.). The decision logic has access to all consumers and can optimize better. For example, for the method 900 steps 904 and 918 may include evaluating whether a threshold percentage, e.g., at least 50%, 60%, 90% or some other value, of a group of consumers that received offers having the attributes of a given step redeemed the offers. If so, then the given step may be determined to be a successful step and other offers may be generated according to the successful step for that group of consumers.

In still other embodiments, offers of multiple merchants for multiple consumers may be evaluated to identify offer attributes that have a high likelihood of redemption and a high benefit for the merchants. For example, heuristics may be developed across multiple Merchants and their consumers to see what attributes (duration, purchase price, benefit) have a threshold likelihood of success (e.g., at least 50%, 60%, 90% or some other value) in different vertical markets to assess what may be considered a fair offer for a consumer before a particular consumer's individual pattern is determined. Accordingly, steps 904, 918 may include determining whether the threshold success rate has been achieved in order to determine whether a step is successful or should be adjusted up or down in the manner described above with respect to the method 900.

The digital offer logic does not necessarily have to only offer one offer to the consumer from any given merchant at one time. In fact, in addition to the best one it selects, as determined according to the method 900, it can also issue additional offers from the merchant's offer Inventory 606. The additional offers may not even fall on the step-up ladder of choices (Table 1) described earlier and may be for an entirely different category of service or product, which may catch the Consumer's fancy, or may just act as an advertisement that such a product or service exists.

Although the service has been described primarily as a digital technology where a merchant application is used to issue an offer that is received by the consumer on his/her consumer computing device 116 (perhaps using the consumer application), there are indeed a lot of people in the world who are not completely into the modern world, especially with mobile phone applications. There are many for whom digital merely means going on the web to a specific URL (uniform resource locator) and clicking on perhaps a coupon advertisement, printing it out, and then carrying it to the store to get it redeemed. This embodiments disclosed herein may also include issuing an offer in the form of a paper coupon. When a digital offer is issued, a consumer receives it as a text message or as a push notification on an app, but it may additionally or alternatively be made available to the Consumer on a webpage that can be reached by the consumer by data contained in a coupon image (e.g., a QR (quick response) code, or a human readable alphanumeric string) that is available for printing and/or cutting out. The merchant application may be programmed to accept this coupon image via either scanning the code or entering the string.

One of the advantages of the offers generated according to the methods described herein is to incentivize the consumer to come back to the store sooner, or within a specific time window. This was illustrated earlier in the format: “See You Soon in <T duration> to receive <a B benefit for a P purchase-value>.”

However, in real life, merchants have a reason to incentivize consumers to not just come sooner, but with additional constraints as well. For example, there could be days when their business tends to be slower, or hours in the day when they have excess capacity to accommodate additional consumers. In these cases, the T duration variable can be interpreted and implemented more broadly to mean any constrained set of choices as they pertain to “when” the consumer will be incented for shopping. So, in this generalized case, the format becomes: “See You Soon in <T time-windows> to receive <a B benefit for a P purchase-value>.”

So, for example, a merchant's offer could be of the form: “See You Soon on Monday or Tuesday next week to receive . . . ” or “See You Soon any Weekday between 2 pm to 5 pm for a free . . . ” T now becomes a set of constraints that define dates, days, and times during which the offer is valid (of if easier to state, the times when the offer is excluded).

Referring to FIG. 9B, in some embodiments, the operation of the service may be represented as an input-output system with static information and intermediate results stored in the database 104. The digital offer logic 610 is designed to work in the cloud where the service is implemented, such as using a server system 102. The digital offer logic 610 interacts with the merchant appliance 114 and its corresponding merchant application as well as the consumer computing devices 116 and their corresponding consumer applications. The merchant application transmits transaction parameters 920 to the decision logic 200. The digital offer logic 610 may implement rules and constraints that are set up in advance by the merchant (or on behalf of the merchant), such as in the merchant preferences 124b

Outputs 924 are transmitted to the consumer, such as the consumer application or by messaging (SMS, email, etc.) in the form of an offer. The offer may also be stored in the mobile wallet 118 of the consumer. The outputs of the digital offer logic 610 may also result in intermediate data 926, which is stored back in persistent storage (e.g. the database 104) in the cloud. The stored data 922 may be reference each time a new transaction is initiated, since the output depends on both the stored state 922 based on past results as well as the current transaction parameters 920.

For example, an offer generated for the consumer based on a most-recent transaction (e.g., according to the method 300) may be generated both on the parameters (e.g., purchase price, identity and category of products purchased) as well as data regarding past transactions of the customer (products purchased, price of items purchased, category of product purchased) and attributes of past offers that have been redeemed by the consumer (duration, price, benefit). In particular, the product that is the subject of an offer may be selected to match the products purchased by the consumer in the most-recent transaction and past transactions and to have parameters (duration, price, benefit) that correspond to past offers that were redeemed by the consumer.

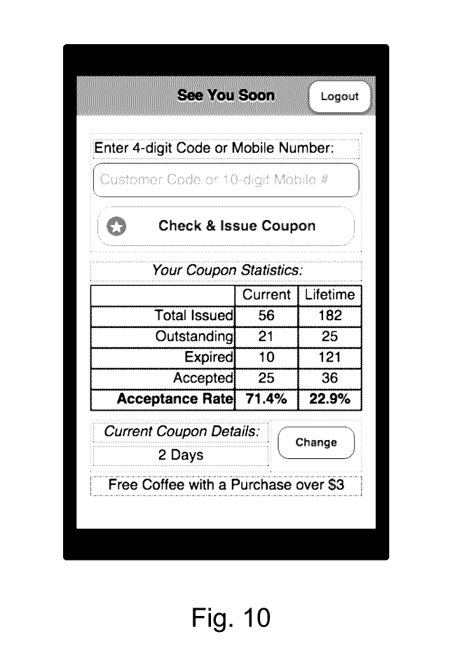

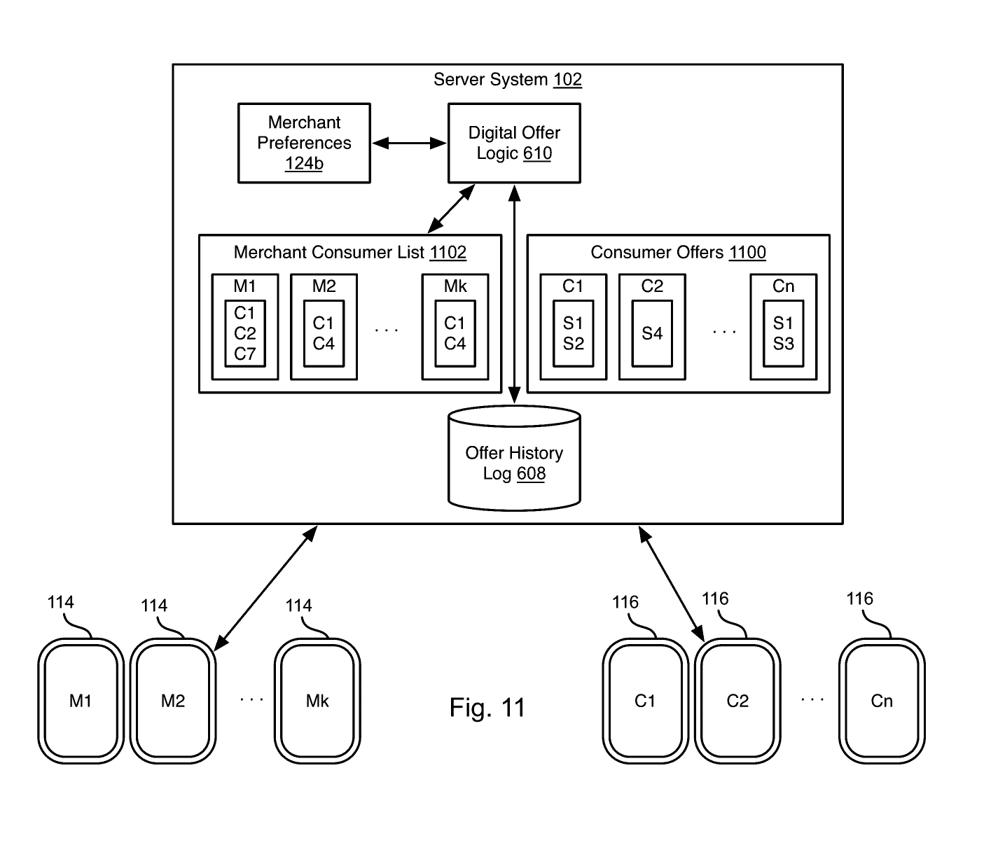

Referring to FIG. 10, a merchant's may have the goal to entice consumers to shop sooner and purchase items of higher value. A merchant may have an offer that is made to all paying consumers. However, it may turn out that the offer (or promotion) is not that enticing to the consumers and no one returns to take advantage of it. Hence, it is important to provide the merchant with ongoing feedback on how well the merchant's offers are doing.

Let us say the Merchant starts with a promotion campaign, which we can call Promo Campaign #1, and gives out say 20 offers, and over a period of several days, a large number (say 15) of these expire with no takers, this can be quite a hint to the merchant to increase the benefit of his offers and make them more attractive via a new promo campaign. In some embodiment, the merchant application shows the key metrics of the Merchant's current campaign, such as by using the interface of FIG. 10.

As shown in FIG. 10, various statistics (“Your Coupon Statistics”) may be shown to the merchant. These values may include a number of offers given (“Coupons Given”), a number of offers that have expired (“Coupons Expired”) and the number of offers that have been redeemed (“Coupons Redeemed”) for a given promo campaign.

The interface may also provides these metrics for previous campaigns, but if screen space on the application is limited, it can provide a lifetime summary for all campaigns, which may include a similar listing of offers given, offers expired, and offers redeemed over the lifetime of the merchant using the service or some other window (e.g., the last year, current fiscal quarter, etc.).

The interface of FIG. 10 therefore advantageously provides quick, ongoing feedback on the success rate of any promo campaign, which can be invaluable to a merchant in refining the promo campaigns dynamically. The service may make these analytics an integral part of the process of generating offers. As shown in FIG. 10, feedback regarding previously-issued coupons may be superposed on the same interface that is used to issue offers to a consumer (see, e.g., the “Customer Code or 10-digit Mobile #” and “Check & Issue Coupon” interface elements).

The current promo campaign offer may also be shown on this screen (“Free Coffee with a Purchase over $3”), along with a button that allows the offer to be changed (“Change”). This makes it simple for the merchant to simply update the offer if the results of the campaign are not looking as desirable as expected. The combination of a single button for invoking issue of offers along with immediate analytics feedback and the ability to make changes to the coupon make this a very powerful system.

In the embodiments described above, a merchant appliance 114 hosting a merchant application is used for capturing the consumer ID and the redemption information about which offer was presented by the consumer to be redeemed, if any. The service may actually use this mechanism to associate the following items with the consumer purchase event: merchant ID, consumer ID, date/time, and offer redemption information.

In the above case, it is the merchant application that communicates all of the four items to the service. However, there are other ways by which such an association can be made, and they do not have to rely on just the merchant application reporting these data items. As long as the association can be made, the digital offer logic 610 can log the event and make the decision on what next to award. A couple other ways of making such an association are described next.

In some embodiments, offers may be represented by a QR code. In this case, the merchant appliance 114 may be a digital tablet running the merchant application that is designed for the tablet. The merchant appliance 114 can display a QR code (or a bar code or just a string of letter/numbers as a code) that is specific to this merchant. In its simplest implementation, the QR code is constant (might as well just be a piece of printed paper with the QR code on it). When a consumer comes, the merchant asks the Consumer to scan the code with his/her consumer computing device 116, such as a mobile device including a camera. The consumer computing device 116 sends this code, or some value derived from it, to the service, which provides a connection to the consumer (e.g., the consumer's phone number or consumer ID that is sent with the message to the service). The service then connects the four data items (merchant ID, consumer ID, date/time, redemption information) above and informs the merchant via a notification on the tablet if the offer (or multiple offers, if so applicable) is valid based on data stored in the mobile wallet 116 corresponding to the consumer ID, e.g., the expiration data of any offer in the mobile wallet 116.

The advantage of a QR Code based system is in simplifying the process significantly for the merchant. As the merchant does not have to do much at all, because it is the consumer that scans the QR code from the tablet. It reduces the burden of training of store clerks at businesses where teaching new skills can be hard. This mode makes this a self-service approach. Either automatically, or if needed, with a push of a button by the Merchant, a new offer can be issued to the consumer. However, a disadvantage of this approach is that it requires the Consumer to have a smart phone capable of scanning the QR code. However, if the QR code is replaced by a string or letters/numbers that are not too long, there could be a provision for the Consumer to just use a texting/SMS service to send the code string to the service to achieve the same result.

If a single QR code is used, there is a potential for fraud or abuse as people can figure that out and try to use it outside of the store. It is for this purpose that there could be an application running on the merchant appliance 114 that is constantly refreshed with a new QR code from the service periodically (every few minutes even), making it hard for someone to utilize the code without being at the store.

In another variation, there is no merchant appliance 114 or merchant application running on it. Instead, the merchant is provided a stack of single-use paper tokens with a unique, one-time-use-only code (or QR code), which can be texted (or scanned) by a Consumer. Except for being on paper, it resembles the QR code on the mobile appliance 114 in the above-described case. The consumer can show the merchant the validity of the coupon on his/her mobile phone if needed when redeeming the token.

The value of such an implementation comes at very low-end merchants that may not have Internet connectivity to run a merchant appliance 114 with the merchant application. Now just by using paper Tokens, and relying on the Consumer mobile phone to communicate with the service, these merchants still have the ability to issue individualized, time-constrained, gamified, offers to the consumer according to the methods disclosed herein. Also, the training is minimal, as this approach is as low-tech as it can get. The main tradeoff here is that the Merchant has to be provided paper Tokens with single-use-code on them.

Referring to FIG. 11, the embodiments described above describe a system enabling a merchant can to increase business through various means of incentivizing a consumer. FIG. 11 illustrates a system that is extended to grow the business well beyond what is possible using a single-merchant approach. Specifically, the system of FIG. 11 may enable leveraging the power of referrals, viral marketing, and networking.

Referrals and viral growth are provided by several existing solutions. However, what does not exist yet in the marketplace are capabilities such as the following:
1. Allowing a Consumer to transfer or forward a special coupon that is coded for that specific Consumer
2. Allowing a Consumer the ability to duplicate or clone a special coupon that is coded for that specific Consumer with or without some restrictions
3. Allowing a Merchant to directly or indirectly incentivize consumers to go to another Merchant using digital coupons or advertising.
4. Allowing a Merchant to put a price tag on giving another Merchant access to his Consumers and get paid for that privilege based on different success metrics

It should be noted that these capabilities may all implemented as a part of the digital offer logic 610 and may be independent of the functionality of the merchant appliance 114, merchant application, and consumer application that are used for communicating with the digital offer logic 610. In other words, whether a merchant appliance 114, a POS 108, or even paper tokens are used to communicate the giving and redeeming of offers to the server system 102, the capabilities of the system of FIG. 11 may be implemented without modification of any of these approaches.

Referring specifically to FIG. 11, merchant appliances 114 and consumer computing devices 116 can communicate with the Cloud in several ways including web browsers, text/SMS messages, and emails too to provide the capabilities described herein. FIG. 11 shows a high-level overview of the Collaboration architecture described in this invention.

Multiple Merchants M1, M2, . . . Mk and multiple consumers C1, C2, . . . Cn are shown, each having a corresponding merchant appliance 114 and consumer computing device 116, respectively. All have merchant appliances 114 and consumer computing devices 116 may have the ability to connect to the server system 102 to access the service in any of the manners described hereinabove.

In the embodiment of FIG. 11, the digital offer logic 610 may be extended to include the collaboration capabilities described below. The service may store consumer offers 1100 for the plurality of consumers C1, C2, . . . Cn, shown as S1, S2, S3, and S4 in FIG. 11. These offers S1, S2, S3, S4 may have originated at any of the Merchants M1, M2, . . . Mn, and the offer history log 608 may include a record of all offers issued.

Each Merchant has a clientele, or consumer base, and these two are shown in the merchant consumer list 1102, wherein each merchant M1, M2, . . . Mk has a list of consumers C1 to C7 associated therewith. There are multiple associations that exist in this system: i) merchant to consumer, ii) merchant to offer, and iii) offer to consumer, (and via social connections), iv) consumer to consumer.

The embodiments disclosed herein use these associations to expand the connectivity to create additional new connections between merchants and consumers in a way that is beneficial to both. For example, by cloning coupons between consumers to introduce new consumers to new merchants.

A merchant clearly wants his existing consumers to return back, and return back soon and buy more, but he also wants to grow his consumer base. Many merchants are willing to provide extreme discounts or deals to attract new consumers to their stores. The service according to the embodiments disclosed herein enables increasing of a merchant's reach to consumers beyond the ones that the offer was given to.

An offer according to the methods described herein is intended to be a special privilege given to a consumer to incentivize the consumer to return to the merchant. It is earned through past purchase and is generally not available to other consumers at the store that may not have been as loyal. However, in some embodiments, a merchant may permit a consumer to transfer the offer to another person. For example, a coupon could be transferred within a family (wife to husband, or mother to daughter or even between friends) if it is more convenient for the other person to take advantage of the services. This capability makes the consumer appreciate this particular business and is indirectly advertising and promoting the business. It is positive for the Merchant too, as it introduces a new consumer to him and increases his chances of someone redeeming the coupon, which effectively helps the business.

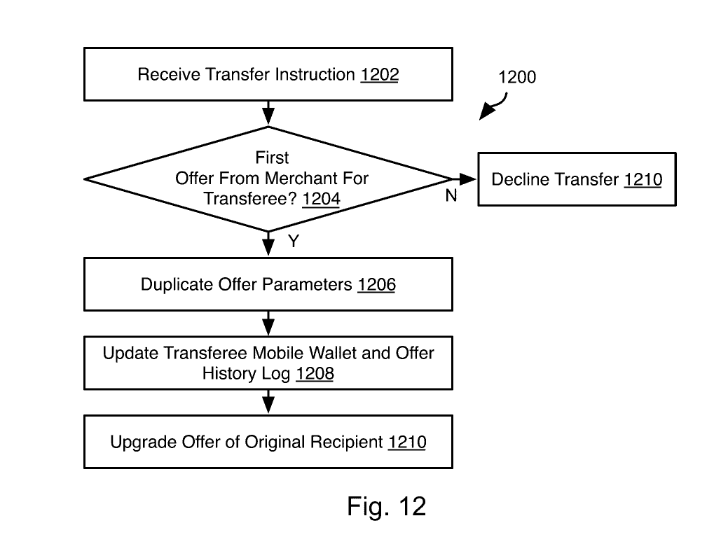

Referring to FIG. 12, while transferring an offer in the form of a paper or digital is like passing on one's concert ticket to someone else to use. FIG. 12 described a method 1200 for offer cloning such that a duplicate copy of the coupon is created. The original recipient retains the original offer, but the referred consumer also received an offer.

The method 1200 may include receiving 1202 a transfer instruction from an original recipient, e.g., from the client computing device of the original recipient using the consumer application. The instruction may reference an original offer and an intended transferee. Upon receiving the instruction, the service evaluates 1204 whether the transferee has previously received an offer from the merchant that is the provide of the original offer. If not, then the transfer is declined 1210. If so, then the offer parameters are duplicated 1206 and the mobile wallet 118 of the transferee is updated 1208 to include the duplicated offer. If so, a message (e.g., text, email, etc.) may also be transmitted to the transferee's consumer computing device 116 in order to communicate availability of the offer. The duplicated offer may also be sent to the consumer computing device 116 of the transferee, such as in the form of a text message, email, or other means. In some embodiments, the expiration date may be reset such that the transferee has the same redemption period from the date of receipt as the original recipient. The offer history log 608 may also be updated to indicate that the offer was conferred on the transferee.

Redemption of the original offer and the duplicated offer may be conducted in the same manner as for any offer disclosed herein, such as according to any of the methods described herein.

Evaluating whether the transferee is a new customer may be determined from the offer history log, e.g., whether or not there is a record of an offer from the merchant to the transferee. In some embodiments, the transaction history 120b of the transferee may be evaluated to determine whether the transferee has conducted previous transactions with the merchant. In such embodiments, cloning of an offer may be restricted to transferees with no transactions with the merchant.

In some embodiments, transfer is permitted where the transferee has redeemed no offers or conducted any transactions within a time period up to the current time, e.g., the last six months or year.

Inasmuch as the service can detect if a consumer has ever been to a merchant, the cloning of offers may be restricted to only new customers of the merchant. This works because merchants are usually willing to give special offers to entice new consumers to their stores, and now they can achieve this through one consumer bringing another consumer virally. At the same time, the Merchant does not have to worry that valuable offers are being distributed willy-nilly.

In many cases, a consumer may clone an offer and give to another person just to help the other person. However, the service may also provide an incentive for a consumer to do so. The consumer who clones the coupon for another person can also get an added benefit. For example, a merchant may specify in the merchant preferences 124b that the original recipient shall be provided an additional benefit in response to transferring the original offer to the transferee. For example, the method 1200 may include upgrading the original offer for the original recipient in response to the transfer, e.g., a next better offer as defined by the merchant preferences 124b, as a reward for having cloned the offer to a new eligible consumer.

For example, a simple automatic upgrade would be to add an additional amount of time to the currently provided offer in some given increments (e.g., “See You Soon in 3 days for xyz” can become “See You Soon in 5 days for xyz”). Adding time is a benefit as it takes some pressure off. Alternatively, the value of discount could be increased. If the merchant so desires, merchant preferences 124b may be configured such that the benefit to the original recipient is only provided if the recipient redeems the cloned offer. This way the benefit is provided more conservatively for actual resulting success to the Merchant. Additional benefits can also be provided depending on how many other parties the coupon was cloned and forwarded to or redeemed. Runaway cascading of cloned coupons can either be encouraged or discouraged based on Merchant preferences. For example, the merchant preferences 124b may be configured to specify only those who have redeemed at the Merchant are permitted the privilege to clone an offer.

In many suburbs and downtown areas, often there are many connected businesses. It is not uncommon that a single person or family may own multiple related or unrelated businesses (e.g., a restaurant, a boutique and a bike shop). Also, many business owners are friends with each other and are happy to drive business to each other. While the previous section described how consumers can bring other consumers in through a viral mechanism, this section describes an approach for merchants to virally expand their reach through offers generated according to the embodiments disclosed herein.

Advertising campaigns are always trying to reach consumers. Some do it through email or direct-mail campaigns, but the success rate of these is often low because of invalid email addresses, or the mail getting categorized as spam or discarded or just not getting the attention of the consumer. Also, it is hard to target the right demographic accurately, and more often than not, one has to spread a campaign very broadly to get a subset of relevant and interested consumers. However, if an advertising campaign or coupon can be handed directly to a consumer, the probability increases that it will be seen and acted upon.

The simplest thing a Merchant can do is to refer another Merchant to join the service implementing the methods described herein. This could be through an invitation via the app or otherwise. If needed, the service may be programmed to incentivize these referrals by giving some reward to the referring Merchant.

Let us say there are multiple merchants participating, M1, M2, M3, M4 . . . . Let us say that M1 wants to collaborate with M2 and sends M2 an invite asking if M2 would like to collaborate, and let us take the case that M2 responds with an affirmative wanting to collaborate.

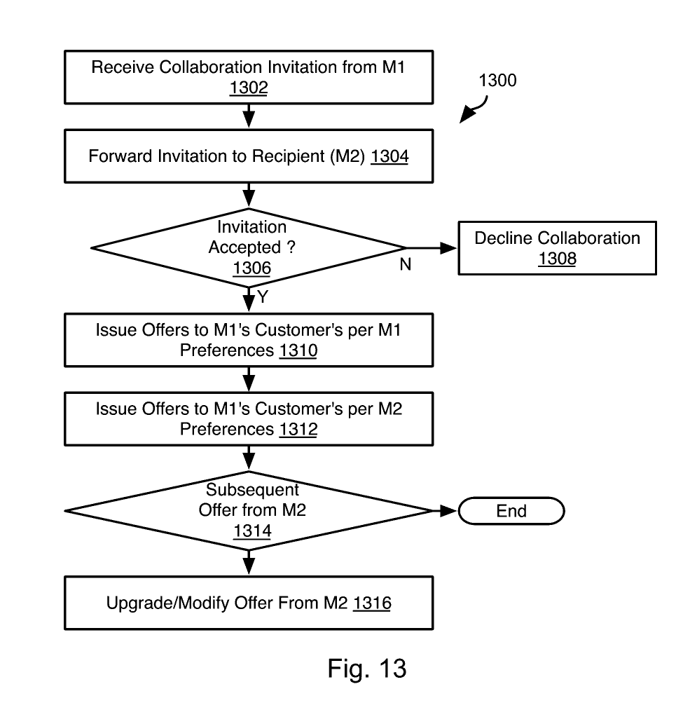

Referring to FIG. 13, the server system 102 receives 1302 the collaboration invitation from M1 and forwards 1304 the invitation to the recipient (M2). If acceptance of the invitation is not found 1306 to have been received, then the collaboration is declined 1308. This may include transmitting a notification to M1 indicating that the collaboration was declined.

If acceptance is found 1306 to have been received from M2, then the remaining steps of the method 1300 may be executed.

M1 may proceed to issue 1310 offers to M1's customers, such as to purchasing customers of M1 (e.g., Cm1a, Cm1b, Cm1c etc.). The method 1300 may further include issuing 1312 offers for M2 to these customers at the same time or at some offset. The offers may be issued on the same printed paper or using the same code that is interpreted by the server system as extension of an offer from M1 and from M2 by the server system 102. The server system 102 may issue 1310, 1312 the offers according to the preferences 124b of M1 and M2 according to the methods disclosed herein, e.g. by adding the offers to mobile wallets 118 of the customers and/or transmitting a message communicating the offer to the customer's consumer computing devices 116. These consumers essentially get two coupons from the two collaborating merchants M1, M2. In this case, M1 may be referred to as a supplier and M2 may be referred to as a Receiver.

In a similar manner, in response to determining that the invitation was accepted, when offers are issued to M2's purchasing consumers (say Cm2a, Cm2b, Cm2c etc.), these consumers are also automatically issued the offer of M1 at the same time or at some offset. Issuing the offers may include issuing the offers according to the preferences 124b of the merchants M1, M2, respectively. These consumers therefore again get two coupons from the two collaborating merchants M1, M2. Here M2 becomes the Supplier and M1 becomes the Receiver.

In some embodiments, if the same consumer is found 1314 to visit M2 such that the same consumer would have received an offer from M2 according to the preferences 124b of M2, then the server system may upgrade 1316 or otherwise modify the offer issued at step 1312, for example the merchant preferences 124b of merchant M2 may specify a first offer, or first level of offer benefit, that are to be issued at step 1312 as part of a collaboration and as second offer or second level of offer benefit for offers that are issued in response to purchases. Accordingly, in response to determining that a purchase of the same customer has been received, the offer of step 1312 may be upgraded 1316 or otherwise modified according to be the second offer or be at the second level of offer benefit.

Optionally, a Merchant may want to exclude giving coupons to consumers that have been to his own store before, as his focus may only be on attracting new consumers that have never shopped with him before. If this is the Merchant preference, the offer may implement this constraint prior to issuing 1312 an offer as part of a collaboration, i.e. step 1312 may be omitted where the transaction history 120b indicates that the consumer has previously received an offer or participated in a transaction with M2.

The rules of issuing offers to existing consumers could be more complex. For example, the previous consumer may be excluded from receiving an offer at step 1312 unless the previous transaction or previously redeemed offer occurred longer than some window prior to the time of execution of the method 1300, in which case an offer would be issued at step 1312.

In effect what the above approach does is actively cross-pollinates the consumers of two Merchants by exposing them to each other. It increases the chance that a new consumer will see the coupon offer of the other store. While it may appear that the previously discussed consumer-to-consumer referral may also expose a consumer to a different store, the merchant-based collaboration is more effective, as in all cases, the offer is given by the service to direct an active consumer that just shopped with one of the merchants. An active shopping consumer, with a shopping interest that is clearly defined through purchasing actions, perhaps in the vicinity of the shopping neighborhood is the dream of an advertiser trying to reach a consumer.

The service may charge a fee to allow merchants to collaborate this way. There are many different models for this, the simplest being a flat fee and the next complex being a proportional or tiered fee depending on how many collaborations are active for a merchant. The fee topic is discussed in more detail later.

This is essentially the same as the previously described merchant-to-merchant collaboration, except that more than two merchants may be collaborating. There can be multiple pairs of collaborators, and any Merchant may collaborate with multiple Merchants at the same time too. The classic “network effect” comes into play, as consumers discover (or are enticed by) more Merchants and the more they crossover into newer merchants, the more likely that they will receive yet another offer that helps them discover a new merchant. A multi-merchant eco-system creates a network of connected pairs that collaborate together.

Merchants that wish to create a close-knit circle where consumers are shared may only invite Merchants within the circle and not invite or accept invitations from outside the circle. Merchants have complete control on who to connect with, both for inviting as well as for accepting invitations. It is possible for the invitations to be set up by default as long-lasting until canceled, or possibly on a periodic (e.g., month to month) basis subject to renewal.

When two merchants decide to collaborate they may have unequal business sizes or consumer traffic. If M1 and M2 collaborate, and M1 has a thriving business with a lot of consumer traffic, while M2 is has a slow business, then this asymmetry can be a cause of concern for M1, as M1 would have little advantage in teaming up with M2, but M2 stands to gain a lot by getting exposure to a lot of consumers. So unless M1 and M2 are family businesses that don't mind the unequal benefits, a mechanism is needed to equalize this asymmetry.

In some embodiments, the service allows the following mechanisms for this situation. For example, the service may charge different fees for M1 and M2 (where M2 pays a higher amount, as he sees a bigger benefit). M1 will receive a cut of this fee and the service will keep the rest. In this way, there is a way M1 can be compensated with money in lieu of the consumer pull that M2 is unable to provide.

Likewise, the above approach can also be used for merchants where it is not necessarily the case that their businesses are of unequal size or traffic, but for some reason, one merchant is more aggressive with coupon giving than the other. In this case, the fee structure can dynamically change based on the metrics of the coupon giving. For example, the fee charged to merchant M2 may be a function f(R1, R2), where R1 is a number of referrals that M1 provided to M2 in the past, or a past window (last N weeks or months) and R2 is a number of referrals that M2 provided to M1 in the same window. The value of f( ) may increase as R1 becomes larger than R2, or larger than R2 by some threshold value. In some embodiments, the value of f( ) may be zero where R2 is larger than R1 or within the threshold value of R1. In a like manner, the fee charged to M2 may be determined according to the same function f(R2, R1).

In one example, M1 is a restaurant and M2 is a hair salon. M1 and M2 do not compete. M1 has a lot of traffic as it is a popular dining place. M2 would love to get its ads shown to M1's consumers to get more people to come to the salon. M1 does not compete with M2 at all, hence does not mind collaborating with M2 to “share” its consumers (the word share here is used loosely to mean that the consumers are shown the ads/coupons of the other merchant), as long as M1 can get some benefit (such as money) for the collaboration. M1 could achieve this by putting a price on his consumers and charging by how many consumers were “shared” with M2 in some way. Such a fee could be charged by the service in response to generating offers according to the methods disclosed herein.

Although the foregoing sections refer to “sharing” of consumers, no lists of consumers are exchanged. A merchant has consumers that shop with the merchant, but may not even have a list or identity of these consumers. When collaboration happens, consumers of one merchant get to see the ads/coupons of another merchant. If the consumer who sees a new ad shops with the other merchant, it appears as if the consumer got “shared”, but in most cases, neither merchant may actual have access to the identity of the consumer inasmuch as the service maintains this in its database 104 and keeps it protected and private. In other words when merchants “share” consumers in a collaboration, they are allowing the consumers to get exposed to the ads of the other merchant.

A collaborative market such as according to the methods disclosed herein may be implemented by the digital offer logic 610. The collaborative market may be understood with respect to the following provisions:
1. A Merchant can be a supplier or a receiver of collaborative offers (according to step 1312, or none, if not participating)
2. A supplier is one that has a consumer base that the supplier feels is valuable and would be of interest to someone else
3. A receiver is one who is looking collaborate with a supplier to get access to the supplier's consumers
4. Any merchant can be a supplier and receiver at the same time, wherein the merchant is a supplier for some collaborations and a receiver for others
5. A collaboration creates a supplier-receiver pair
6. A supplier's intent is to make money from the asset (the consumer list) they possess; a receiver is willing to pay to get visibility/advertising from that list; the service makes money from the fees it charges for the collaboration connections and transactions that take place between the supplier and receiver.
7. The supplier's responsibility is to advertise the receiver's offers (e.g., coupons, deals, advertisements, etc.) to the supplier's consumers simultaneously whenever they receive the supplier's offers (see method 1300, FIG. 13).
8. Advertising of coupons can come with additional restrictions such as “New Customers Only,” as described above. These may be specified as preferences to the service at the time the collaboration is agreed to.
9. Collaborations can be created in one of many ways:
   a. A supplier may send an invite to a receiver with pricing which the receiver accepts, e.g., the invitation received at step 1302 and forwarded at step 1304 of the method 1300.
   b. A receiver may send an invite to a supplier that the supplier responds with the pricing and the receiver accepts, e.g., the invitation received at step 1302 and forwarded at step 1304 of the method 1300. In this case, the acceptance detected at step 1306 may include specification of pricing.
   c. A supplier may openly advertise that the supplier is willing to collaborate and post a price list and then when receivers apply, agree to collaborate with some or all of them.
10. Collaborations are optional and suppliers and receivers can opt out of collaboration if so desired
11. The marketplace works where a supplier lists the price at which supplier is willing to share the supplier's asset. If the price is acceptable to any receiver, a request for collaboration will be received 1302 by the supplier, which the supplier can accept or decline depending on whether the supplier believes the receiver is a competitor or not.
12. If needed, the supplier can lower the price to get more takers. If the demand is high because his consumer base is considered precious, he can raise the price. Price changes can be allowed on certain boundaries (e.g., end of the month) so that they are locked down for a period of time to provide continuity and stability. Pricing can also be seasonal as the supply and demand can vary.
13. Pricing can be offered with differing price tiers for different outcomes:
   a. Giving out an offer
   b. Giving out an offer that is successfully redeemed.
14. In some embodiments, a supplier could have different pricing for different receivers.
15. The service may be programmed to artificially decide to restrict the maximum number of collaborations per merchant to ensure that the circulating offers remain valued and precious and do not get categorized as “spam” by the consumer. If the collaborations are limited, merchants may rotate and change their collaborations over time if there are more receivers wanting to collaborate with them.
16. Merchants can earn ratings on their success rate. If the offer referrals from a certain merchant result in higher redemption success, the merchant's rating will be high. This in turn will allow the merchant to charge a higher premium as a supplier. Essentially, this becomes a marketplace where pricing decisions result from supply and demand as well as measured success via ratings.

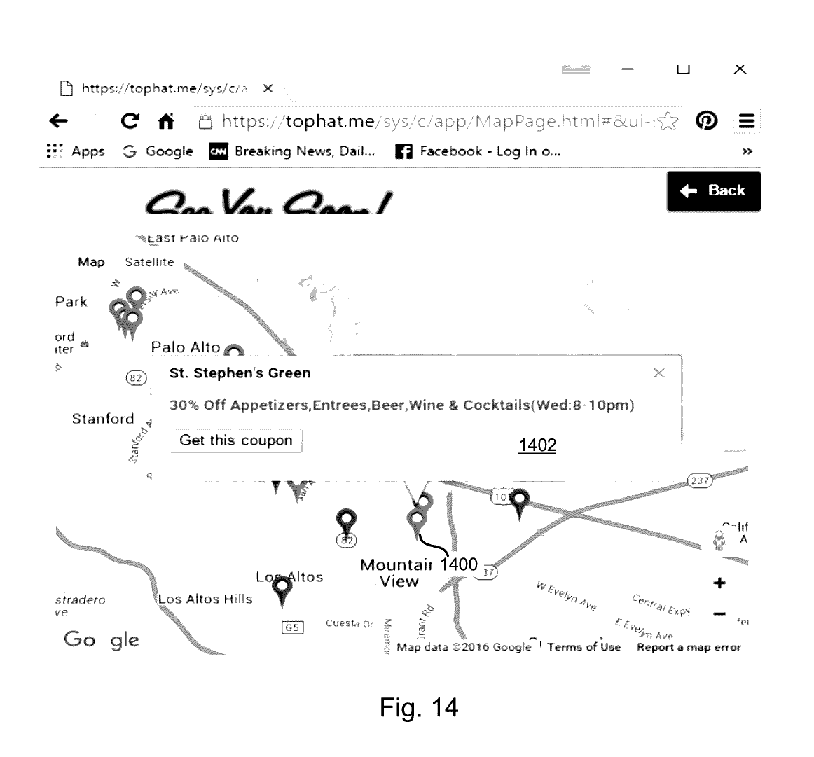

Referring to FIGS. 14 through 16, novel incentive mechanisms for consumers and merchants are described. Embodiments are disclosed that enable small and medium businesses to increase their sales through the use of offers, which may be in the form of paperless digital coupons (sometimes referred to as eCoupons) which are issued to consumers electronically and do not need to be printed or cut.

In particular, the embodiments disclosed herein provide for self-service digital coupons and includes new and additional innovations for digital coupons in four main categories: i) easier and broader distribution methods, ii) easier redemption methods, iii) creating engagement with digital coupons, and iv) increasing the effectiveness of coupon issuance and usage using a two-step gamification using a good-deeds reward point system.

In particular, in any of the methods described above, an offer may be generated using the same approach except they are self-generated by the customer instead of being generated by a merchant in response to a purchase, referral, or other action described above as invoking generation of an offer. The manner in which an offer may be self-generated by the customer is described in greater detail below.

The self-generation of coupons may include issuing digitally defined offers, such as a digital coupon (also referred to as eCoupon), which may include an offer (which can be any kind of discount, benefit, sale price, free-bee, voucher) that is made available so that it can be retrieved via the web, email, social media, or other source, and that can be presented, accessed, and verified electronically. Digital coupons do not have to be printed or cut out.

In a cloud-based solution, the service may provide a link to a digital coupon, such as a URL (uniform resource locator) and it is this URL at which a given digital coupon can be found. A link such as this can be made visible publicly if the intent is for the offer to be open to all, or can be restricted and require some kind of password or criteria to be met in order to be accessible.

The self-generation of offers described below extends the functionality of offers described above to make it easier to distribute or spread the use of the coupons and also make them more effective as they get used.

While the method described above relied on a customer visiting a merchant location to receive an offer, the methods described here enable a customer to receive a coupon in alternative ways.

In this case, the coupon is advertised by a third party site. The advantage of this is that someone that visits an affiliate site may then find a coupon and show up at a merchant. In this scenario, the initial coupon does not originate with a customer going to the merchant first. Examples of affiliate marketing sites include i) online newspapers and news-magazines, ii) Chamber of Commerce or Downtown Association website, or iii) any individual with a website that wants to redirect traffic to a merchant they wish to promote.

The offer may be listed as a coupon, or it may show up by clicking on an advertisement for a merchant on a page or a sidebar on the webpage. The coupon may also be displayed in a searchable array of multiple coupons laid out on a web page. It may also be accessible via a map with markers that can be clicked to reveal the coupon.

An affiliate site essentially entices a visitor to their site to click on a coupon. All such click through actions that are measurable and benefit the affiliate in some way, whether it be monetary or otherwise. The coupon is self-issued by the customer, which means the customer clicks on it and provides any necessary information if required (e.g., mobile number, email or other identity such as Facebook/Twitter etc.) to receive it. Since this is a digital coupon, the coupon does not get printed, but rather emailed/texted to the receiver. Self-service coupon mechanisms can increase the traffic to any business over and above what they may otherwise get.

Aside from self-service and merchant-issued offers, another mechanism that the service may implement is to automatically issue one or more offers automatically for having shopped someplace. The new offers may be issued by the service randomly or may be systematically derived from the customer's shopping pattern. Alternatively, the customer may be given the privilege to self-issue coupons up to a certain limit.

A merchant may decide to distribute offers, e.g., digital coupons, via email distribution to their contact list of customers or prospects. Essentially, the email would have a link to the digital coupon provided by the service (a link that is unique to each coupon), which when opened redirects to where the coupon can be self-issued, much like the case with affiliate marketing redirection. The email could also have an image to which this specific digital coupon link could be associated with so that clicking on the image can achieve the same result.

Offers, e.g. digital coupons, may also be self-issued using social media. In this case, the digital coupon link can be posted to social media sites such as FACEBOOK, TWITTER, INSTAGRAM, LINKEDIN, SNAPCHAT and PINTEREST etc. The link may also be associated with an image so that clicking the image could redirect to the link. Some social media platforms do not allow an external links to be associated with an image. FACEBOOK is an example of this. However, in case of Facebook, given a URL, it can extract an image if present on that URL and then associate the image with that URL. Using this knowledge, the link can be placed at specially designed URLS that contain both the link and its image so that such linking can be done.

Referring specifically to FIG. 14, as stated earlier, offers from multiple merchants can be displayed in a searchable, sortable array of offers. It is also common for numerous websites to show participating merchants on a map for any purpose (e.g., to show ratings, or deals, or categories/types etc.). Typically, some kind of a map marker 1400 is used to show all businesses that meet some selection criteria. These markers 1400 can be color coded or may have different illustrations to that visual categorization is easy. It is also common for the marker to be clickable so that it shows more details about that location or business including name, address, hours, URLs, menus etc. Sometimes such a marker when clicked may open a side-bar panel with more details, and at other times, it may just have a pop-up box near the marker, on top of the map with the information in it.

The service according to the embodiments disclosed herein may provide an ecosystem that offers a range of offers to customers, such as digital coupons and cashback rewards. When information 1402 for merchants participating in the service is displayed on a map for a given user, they visually indicate via icon color, shape, illustration and size several key pieces of information that a customer may want to know. This information 1402 may include:
1. Retail Type: Businesses categorized by restaurants, boutiques, bookstores, pet-stores etc.
2. Partner Type: General, Chamber Of Commerce, Down Town Association, Charity/School etc.
3. Offer Type: Coupons only, Cashback only, Coupons+Cashbacks etc.

When any such marker 1400 is clicked, a pop-up box 1402 can open and, if the consumer has a digital coupon from a merchant, the pop-up box 1402 may show the content of that coupon (or coupons if there are multiple) right on the pop-up box or on a side-bar panel. If the customer does not have a coupon, and if the merchant offers a coupon available to the public, it shows what the coupon offer is.

In order to self-issue a coupon, the customer clicks on a merchant marker 1400 that provides an offer that the consumer does not already have in the consumer's mobile wallet 118. The service may implement a one-click coupon-issue where simply clicking on the coupon button on a pop-up for the marker (“Get this coupon”) causes the service to place the offer, e.g., digital coupon in the customer's mobile wallet 118. This instant issue capability is novel and does not exist in the marketplace. This capability is also of significant value because of the popularity of coupons to begin with, which get enhanced by becoming digital and doubly enhanced by making them trivially easy to retrieve (without having to enter a mobile phone or email etc. once already implicitly or explicitly logged in to a website).

This technique allows a customer to visually look at a map and tell which merchants of what types are in the vicinity and which one he/she already has a coupon for. For example, markers 1400 for merchants providing offers that are not currently in the mobile wallet 118 of the consumer may be visually distinguished (color, shape, text, etc.) from those that do not correspond to merchant's that provide offers that are not currently in the mobile wallet 118 of the consumer.

The consumer may therefore select the marker 1400 indicating an available offer in order to invoke addition of the offer to the consumer's mobile wallet 118. This is shown in FIG. 14.

Redemption of self-issued offers may be performed in the same manner as describe for the methods described above. In particular, the method 300 as described above may be used.

In some embodiments, the service allows for another option called “open loop” to make it easier for merchants to deploy self-issued offers. In this case, the merchant does not have any merchant application or merchant appliance 114 to mark whether a coupon was used by a consumer or not, making it much easier to deploy. This works for cases where the discount given is such that the merchant does not mind giving it over and over again. Here the consumer brings the offer, e.g., digital coupon, on the consumer's mobile phone and the merchant simply honors it. The consoumer could come back repeatedly till the expiration date, or may even self-issue a new coupon if needed. When a merchant uses an open loop approach, there is no tracking of who and how often the customers returned.

Various other functionality may be implemented by the service to increase customer engagement so that the digital coupons are more successful (as measured by how often they are used resulting in incremental sales to the merchants). Clearly, having lots of merchants and lots of customers creates activity, but the following techniques either increase engagement or make the activity more effective.

If the merchants keep on changing their offers on a periodic basis, where their offers get better or worse, it gives a reason for the customer to look periodically to see if a deal of their liking shows up. When multiple merchants visible on a common website are varying their offers, asynchronously in time with each other, the process gets competitive and interesting to the consumer as they have to make real-time decisions on which one to pick.

While digital coupons would be one approach to draw consumers to a website to get a coupon and then to the store to use it, there are other engagement mechanisms that draw a customer in through a different excuse. For example, merchants do post on social media and customers may follow them there. However, since the service creates a portal that can cross-pollinate the customers across multiple merchants, it can also be a place to post something brief but catchy that, just like a coupon, can catch the eye of a consumer for a merchant that the consumer may not even be familiar with (or connected on social medial). The service may therefore allow merchants to update a “banner” just like they can update a coupon, and this can be varied frequently to catch a customer's attention. The banner may also get linked to a merchant's social media feed, such as a Twitter feed. For example, a banner can be used for events postings such as “Reading by Author X at the Bookstore tonight”, or “New Jazz band at the Café tonight” etc. This is a soft way to become visible to a customer.

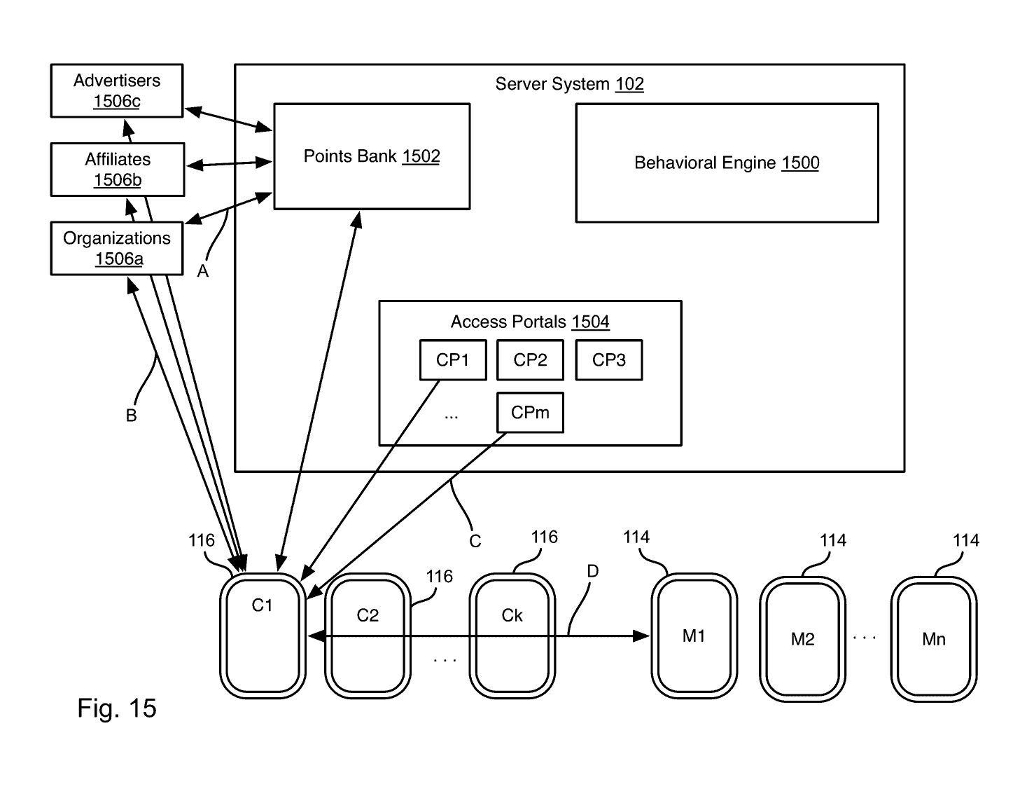

Referring to FIG. 15, the service may implement the illustrated system in order to increase the effectiveness of offers, such as digital coupons or cashback rewards (which ultimately increases the overall shopping), by providing mechanisms that reward the desirable behaviors of consumers and merchants. This is based on a few key behavioral observations such as i) when a resource is available in limited quantity, it gets valued more, ii) rewarding the desirable behaviors (and perhaps penalizing the undesirable ones) can lead to better outcomes, and iii) incrementally involving consumers in the desired outcomes has a lasting effect. In this gamified approach, the ability to self-issue coupons is coupled with constraints to create an environment where every action counts and gets valued and appreciated more.

The following are outlined for the purposes of this description. In the simplest case, a consumer goes to a store and makes a purchase and we refer to this as a zero-step process, as there is no additional step needed before making the purchase. A one-step shopping process would be one where a consumer gets a coupon in some form (paper or digital coupon), and then takes it to the store to make a purchase.

The service may implement an embodiment providing a two-step process using the concept of “Karma Points,” which has the potential to increase the shopping success rate. The term “karma” colloquially represents the concept of “whatever one does comes around”, and in that sense, if you do good karma, then good things will happen to you. In the embodiments disclosed herein, Karma Points are used to measure good deeds or behaviors (that help promote shopping). These points are rewarded for good deeds (and subtracted for undesirable actions) and at times can be redeemed for some benefit (the benefit here is in the form of offers, such as digital coupons, which save the consumer money while making a purchase).

The two step process includes (1) adding Karma Points to the mobile wallets 118 of consumers by the service in response to receiving reports of a certain set of actions from merchants; (2) processing, by the service, instructions to purchase offers using the Karma Points. The offers may be stored in the mobile wallets 118 of consumers and redeemed in the manner disclosed herein. A Karma Points account may be debited in response to the purchases.

This two-step process has numerous benefits, such as:
1. Karma Points accumulation is gamified. In other words, it is made into a game which makes it fun to participate in.
2. Karma Point accumulation is tied to deeds or actions (with good ones getting rewarded) both non-monetary as well as monetary purchase actions. A range of behaviors can be rewarded with points including i) Liking/Sharing us or someone on Facebook, ii) Tweeting about us, iii) Referring a friend, iv) Referring a business, v) Using a Coupon, vi) Shopping actions, vii) Visiting partner/advertiser websites, viii) Clicking on sponsored ads etc. Correspondingly, points can be subtracted for actions that are to be discouraged.
3. Since spending money is not a pre-requisite to earning Karma Points, consumers can keep accumulating Karma Points through simply good deeds.
4. Merchants can have a range of offers, e.g., coupons, they can offer to their consumers. The basic Coupons can be free, but Coupons with a better deal may have a price tag on them, with the price being in Karma Points. So, a very special Coupon may cost say, 5 Karma Points, and a consumer can use his/her Karma Points from the mobile wallet to obtain this special Coupon by redeeming these.
5. The key thing to note (compared to points solutions such as mileage points etc.) is that points do not directly buy goods/services, but they buy Coupons, which are a right to buy goods/services as a discount or some other benefit.
6. The offer may include a coupon or any form of deal, discount, freebee, voucher, cashback reward, etc.
7. An offer is a right to purchase goods/services. It is optional to use, but during the valid duration of the offer, there is a benefit received.
8. The two-step approach creates a level of indirection, in that first there is a step to accumulate Karma Points (which is typically made easy, fun, and even free), and then there is a second step to acquire an offer (and potentially a coveted, special coupon) with the Karma Points.
9. The principle at work here is that by the time someone acquires an offer, they are well-invested in the process. The offer itself was acquired through a relatively low dollar cost (as the Karma Points could have been mostly freely earned good deed points), but now that the offer is in hand, it is a strong reason to use it rather than let it go waste. In other words, it is a way to get a consumer closer to subconsciously committing to a purchase without explicitly committing to it.

FIG. 15 shows the high-level architecture of Karma Points gamification system. The server system 102 may implement a cloud-based service that implements and delivers the two-step gamification described herein. In particular, the server system 102 may execute a behavioral engine 1500 that includes a database of consumer and other actions that may be tracked and monitored. The behavioral engine 1500 collects information from transactions processed by or reported to the service, such as according to the processing of offers generated and redeemed according to the methods described herein and other transactions reported to the service by consumers, merchants, partners, and web portals.

The behavioral engine 1500 may be a rules based engine that can analyze the transactional data and determine one or more desirable actions (as well as undesirable ones) to make a determination in the rewarding and/or redemption of Karma Points. The behavioral engine 1500 may also reward the good behavior of Merchants. In this sense, there are also “Karma Points for Merchants” which are measures of how active and engaged a merchant is in the process, and the reward for good deeds could be as simple as more visibility on advertising portals and platforms. The Karma Points for merchants may be an internal measurement that is not shared back with the merchant like the consumer Karma Points are, although they are presented to the merchants in some embodiments.

A Karma Points bank 1502 may be an extension of the behavioral engine 1500 and operate as a central bank that is responsible for creating and releasing Karma Points into the entire system. No other entity can create Karma Points other than the bank 1502. Typically, it creates new Karma Points as needed as new consumers start participating. It drives a balance in deciding how many to release. If too many are released, every consumer could get too many, and their value or importance may get reduced. If there are too few, the threshold to buy something interesting may be too high inhibiting healthy transaction volume. Working hand in hand with the information from the behavioral engine 1500, the bank 1102 is programmed to attempt to identify an optimum balance of circulating Karma Points so that it is valued. Specifically, the bank 1502 may be programmed to set the number of Karma points circulating effective to have a balance between the two extremes of scarcity and over-abundance. In other words, it is the driver of Karma Points monetary policy, some of which is algorithmic and some of which may require human input from the management team of the service.

The server system 102 may further implement a plurality of offer access portals 1504. The portals 1504 may be embodied as websites provided by the service where consumers can redeem their Karma Points to get offers. In other words, they can purchase offers on this site using Karma Points. Some offers may be free as well. Typically, an array of offers from multiple merchants would be displayed on these sites (labeled CP1 to CPm in the figure), with a way to search them by category, popularity, recency, Karma Points cost, expiration date etc. Additionally, the service may display offers from different merchants with varying degrees of prominence depending on other factors (e.g., results from the behavioral engine 1500, fees/revenue potential, sponsored category etc.). In this sense, the behavior engine 1500 is also rewarding good behaviors and actions from merchants too. Merchants publish offers via the service, which will be displayed in the portals 1500. Consumers may acquire them using Karma Points. Merchants may change their offerings or lower their cost of acquisition based on whether they are effective or not. Typically, an offer includes the following pieces of information determined by the Merchant, referred to here as offer properties:

1. Benefit Description (e.g., 10% off, buy one get one free etc.)

2. Dates during which Coupon is to be posted

3. Maximum quantity of Coupons to be issued

4. Expiration Date or Duration Date (e.g., 3 days from issue) for the use of the Coupon

5. Cost in Karma Points

Merchants (shown as M1 to Mn in FIG. 15), offer goods, services for purchase, and offers that enable consumers to purchase these at a discount. As stated earlier, merchants may give discounts via the offers, and the offers may also represent the cash-back offers from the merchant. Merchants determine the offer properties and can change them. Changing these properties is a privilege that is earned by good merchant behavior and the service may give merchants a set of privileges. The offer properties may be specified in the merchant preferences 124b of the merchant.

The ultimate goal the service is to incentivize merchants to generate desirable offers and consumers (denoted as C1 to Ck in Fi. 15) to make purchases with them. If an offer is freely offered, as in many cases on the web today, the consumer simply gets that offer and shops. However, if the offer has a cost in Karma Points associated with it, the first step for the consumer is to earn Karma Points to be able to afford purchasing a coveted offer. The consumers may track a variety of shopping information, and the mobile wallet 118 of the consumer may be used to track offers that are available to the Consumer. The mobile wallet 118 may store such information as:

1. Karma Points earned and available

2. Offers 120d that have been acquired (and still not expired)

3. Cashback Rewards 120c that have been earned and available to spend

The service may form partnerships with entities 1506a-1506c to help promote shopping. These entities could be companies or non-profit organizations. For example, if a company partnership can result in merchants being added to the ecosystem implemented by the service, it could be a partner. Similarly, if another company can bring in consumers to the ecosystem, it too is a candidate for being a partner. A partner is one where a relationship with the service result in a win for both parties. Typically, a partner would have an interaction with consumers. A partner is given a pool of Karma Points by the service to disseminate to Consumers as it chooses, in return for some kind of good deeds that the organization specifies. For example, some charities may give Karma Points to consumers for social or community service to encourage more volunteering. The Karma Points given to a partner may be either one-time or periodic and may be based on certain expectations being met of the partner. Partners may classify into a few main categories.

Organizations 1506a may include charities, churches, schools, non-profits, chamber of commerce organizations, downtown associations, industry associations (e.g., wineries, bookstores etc.).

Affiliates 1506b may be smaller entities than Organizations, and their roles and actions may be simpler too. Affiliates are those that redirect traffic from their business or site to the portals 1504 by introducing their clients to Karma Points. For example, a dentist office may become an affiliate and thank its patients for getting checkups on time by giving them Karma Points, which are indirectly just a way for the patients to acquire an offer of their choice from an access portal 1504. The dentist's office generates the goodwill of its patients while providing them a benefit. The service may periodically replenish the Karma Points of an affiliate 1506b based on the criteria it chooses.

Advertisers 1506c may be entities that want their site or product to be noticed, tested or used and would be willing to give out Karma Points to visitors for certain actions (click on an ad, view a video, subscribe to a newsletter etc.). Advertisers 1506c will need to buy Karma Points from the service to give away to its visitors. The access portals 1504 along with other places may have pointers for consumers on how to get more Karma Points if they don't have enough, and these pointers may include links to advertisers 1506c to help drive traffic to their site.

There are several relationships between the different stakeholders and these are shown with an arrow in FIG. 15. There are links A between the server system 102 and the partners 1506a-1506c. Partners provide some kind of value in the form of customer engagement, merchant engagement, or money to the service. In return the service provides them a one-time, or periodically replenishable, stock of Karma Points to give to their patrons as a reward for good deeds.

There are links B between partners 1506a-1506c and customers C1 to Ck whereby where good deeds or desirable behaviors are rewarded with Karma Points. The service may also directly reward consumers with Karma Points for shopping (or an excuse such as a monthly raffle drawing etc.), and the partners 1506a-1506c may reward for a good deed as perceived by them.

Link C illustrates the action whereby consumers use access portals 1504 when they have some accumulated Karma Points may go to the access portals 1504 and exchange their Karma Points for one or more offers.

Link D illustrates the connection between consumers C1 to Ck and merchants M1 to Mn as the consumers make a purchase by redeeming their offers, which is the main goal of the Merchant—to get a Consumer to shop at their store.

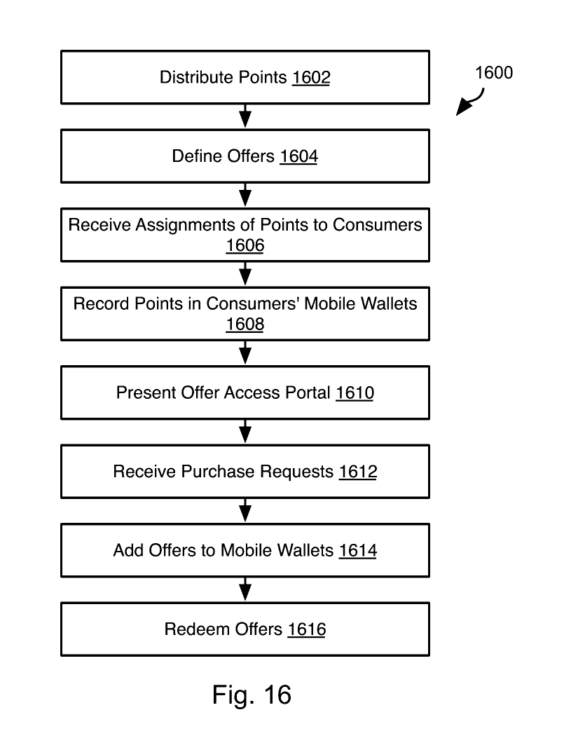

Referring to FIG. 16, the illustrated method 1600 may be used to implement the distribution and use of Karma Points.

At step 1602, the service distributes a pool of Karma points to one or more partners 1506a-1506c. This may include updating a value in accounts of the partners 1506a-1506c indicating that the points are available and transmitting a message indicating that the amount of points are available to distribution.

The service may further define 1604 offers according to parameters specified by merchants, such as merchant preferences 124b. For example, the service may transmit requests to merchants to issue a range of offers of increasing value starting with some that are free, and others that have a Karma Points cost associated with them. The more the cost, the higher the benefit provided by the offer. It is also natural that the more the benefit of the offer, the fewer of these that would be offered and perhaps less frequently too.

The method 1600 may further include receiving 1606 notifications of assignments of points to consumers. In response to such notifications from a partner 1506a-1506c, the service records 1608 the assignment. This may include deducting the assigned points from the account of the partner that issued the notification and adding the points to the mobile wallet of a consumer referenced in the notification, such as by the consumer's phone number or other identifier.

As noted above, consumers can earn Karma Points constantly for their good deeds at any time and be rewarded by the service or the partners 1506a-1506c. Different good deeds may have different number of points and these points accumulate in the consumer's mobile wallet 118.

Partners 1506a-1506c may assign Karma Points as they wish. These are typically awarded using a consumer's mobile phone number as the identification of the mobile wallet (but can also be associated with email ID or other social media IDs such as Facebook & Twitter).

The service may be programmed to record 1608 assignments of points to consumers without first receiving an assignment of points from a partner. For example, the service may deposit the points into the consumer's mobile wallet 118 and may provide an optional notification of the reward. Karma Points can be given as a reward for redeeming offers or for other purchases that result in cashback rewards. Potentially, Karma Points can be subtracted for receiving an offer but not redeeming it.

The process of distributing 1602 Karma Points to partners may be ongoing such that the service replenishes the Karma Points available to its Partners, such as according to agreements with them.

Merchants may change offers provided to consumers and their properties, including Karma Points cost, availability etc. as per the privileges given to them. This means better offers may show up periodically in the access portals 1504 or may disappear from the portals 1504.

The offers defined by merchants may be presented 1610 to consumers through the access portals 1504 or other platforms, e.g., social media. Consumers may keep an eye on the Coupons being offered through the portals 1504 and decide to buy one or more offers using Karma Points in their mobile wallets 118.

Accordingly, the service may receive 1612 requests to purchase offers in portals. The service will then add 1614 the purchased offer to the mobile wallet 118 of the requesting consumer and deduct the price of the offer from the Karma Points recorded in the mobile wallet 118 of the requesting consumer. In some embodiments, the offer may also be transmitted to the consumer's computing device 116 in response to purchase of the offer. Offers purchased maybe redeemed 1616 or expire in the same manner as any of the methods described herein.

Purchasing offers according to the embodiments disclosed herein has an element of chance. A consumer does not know if any offer on the site is going to stay longer or disappear, though the service may this as a part of the offer properties set by the merchant but witheld from the consumer. There is a chance that a great offer may disappear the next day. There is also a chance that a better offer may show up the next day. The unpredictability makes this game fun!

In some embodiments, offer information is provided to the Consumer. This includes how many offers of that type were issued and how many have been redeemed, and how many are still left. This allows for some data driven decisions about popularity.

In some embodiments, Karma Points earned don't stay forever. Over time they are forfeited, e.g., the service may note the date that karma points were added to the mobile wallet 118 of the consumer and remove them from the mobile wallet after some expiration point of they are not used. This creates an incentive to “use it or lose it”. Good deeds can help add to the pool. In a sense, the Karma Points are in a bucket with a hole that leaks points slowly.

Given a limited set of Karma Points in the mobile wallet 118, the Consumer has a choice of either using these to purchase the best affordable offer at that point, or to do some additional good deeds to gain extra points to be able to get an even more valuable offer, or just wait for a better offer to show up. However, since Karma Points do decay with time, the strategy suggests reasonably quick action over waiting forever. The merchants have a strategic choice too of discounting enough to spur significant traffic, but controlling the number of very steeply discounted deals so as to not hurt their margins. They can do this dynamically by getting the analytics on the number of people who have viewed, purchased and redeemed their Coupons. And finally, the service, as a Karma Points banker can release more or less Karma Points into the ecosystem to spur or curb the activity.

Ultimately, what makes a game fun is the engagement that the players have. In this approach, the service strives to achieve a higher shopping revenue while engaging the consumer with an activity that is a prelude to shopping but not direct purchasing itself. The game does not have an end, as the process simply continues with all the stakeholders doing their part to maximize the benefit for themselves.

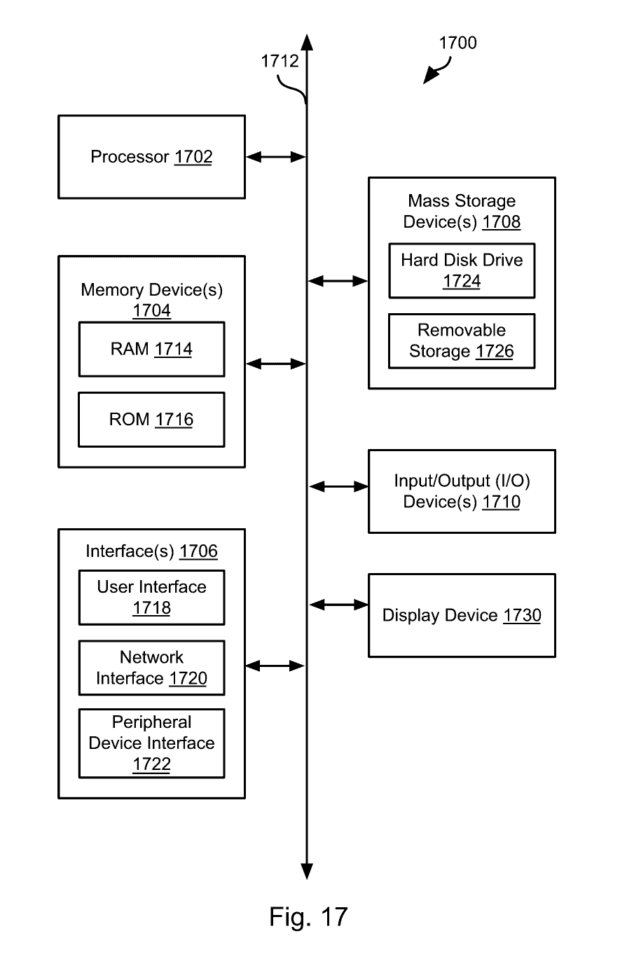

FIG. 17 is a block diagram illustrating an example computing device 1700 which can be used to implement the systems and methods disclosed herein. The server system 102, database 104, POS 108, merchant appliances 114, and consumer computing devices 116 may have some or all of the attributes of the computing device 1700. Computing device 1700 can function as a server, a client, or any other computing entity. Computing device 1700 can perform various monitoring functions as discussed herein, and can execute one or more application programs, such as the application programs described herein. Computing device 1700 can be any of a wide variety of computing devices, such as a desktop computer, a notebook computer, a server computer, a handheld computer, tablet computer and the like.

Computing device 1700 includes one or more processor(s) 1702, one or more memory device(s) 1704, one or more interface(s) 1706, one or more mass storage device(s) 1708, one or more Input/Output (I/O) device(s) 1710, and a display device 1730 all of which are coupled to a bus 1712. Processor(s) 1702 include one or more processors or controllers that execute instructions stored in memory device(s) 1704 and/or mass storage device(s) 1708. Processor(s) 1702 may also include various types of computer-readable media, such as cache memory.

Memory device(s) 1704 include various computer-readable media, such as volatile memory (e.g., random access memory (RAM) 1714) and/or nonvolatile memory (e.g., read-only memory (ROM) 1716). Memory device(s) 1704 may also include rewritable ROM, such as Flash memory.

Mass storage device(s) 1708 include various computer readable media, such as magnetic tapes, magnetic disks, optical disks, solid-state memory (e.g., Flash memory), and so forth. As shown in FIG. 17, a particular mass storage device is a hard disk drive 1724. Various drives may also be included in mass storage device(s) 1708 to enable reading from and/or writing to the various computer readable media. Mass storage device(s) 1708 include removable media 1726 and/or non-removable media.

I/O device(s) 1710 include various devices that allow data and/or other information to be input to or retrieved from computing device 1700. Example I/O device(s) 1710 include cursor control devices, keyboards, keypads, microphones, monitors or other display devices, speakers, printers, network interface cards, modems, lenses, CCDs or other image capture devices, and the like.

Display device 1730 includes any type of device capable of displaying information to one or more users of computing device 1700. Examples of display device 1730 include a monitor, display terminal, video projection device, and the like.

Interface(s) 1706 include various interfaces that allow computing device 1700 to interact with other systems, devices, or computing environments. Example interface(s) 1706 include any number of different network interfaces 1720, such as interfaces to local area networks (LANs), wide area networks (WANs), wireless networks, and the Internet. Other interface(s) include user interface 1718 and peripheral device interface 1722. The interface(s) 1706 may also include one or more user interface elements 1718. The interface(s) 1706 may also include one or more peripheral interfaces such as interfaces for printers, pointing devices (mice, track pad, etc.), keyboards, and the like.

Bus 1712 allows processor(s) 1702, memory device(s) 1704, interface(s) 1706, mass storage device(s) 1708, and I/O device(s) 1710 to communicate with one another, as well as other devices or components coupled to bus 1712. Bus 1712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1700, and are executed by processor(s) 1702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, by a server system, a request to generate an offer for a consumer;
in response to receiving the request, generating, by the server system, an offer having a custom expiration date determined according to a transaction history of the consumer; and
transmitting, by the server system, the offer to a consumer computing device corresponding to the consumer.

2. The method of claim 1, wherein receiving the request to generate the offer comprises receiving the request to generate the offer from a merchant computing device, the offer being issued on behalf of a merchant associated with the merchant computing device.

3. The method of claim 1, wherein receiving the request to generate the offer comprises receiving the request to generate the offer from the consumer computing device.

4. The method of claim 1, further comprising:
receiving, by the server system, from one or more affiliate computer systems, assignment of points to the consumer; and
wherein receiving the request to generate the offer comprises receiving, from the consumer computing device, a request to purchase the offer using the points.

5. The method of claim 1, wherein the consumer is a first consumer, the method further comprising:
receiving, by the server system, from the consumer computing device, a request to clone the offer; and
in response to receiving the request to clone the offer, adding, by the server system, a copy of the offer to a mobile wallet of a second consumer.

6. The method of claim 1, wherein the offer is a first offer, the method further comprising:
receiving, by the server system, a request from a first merchant to collaborate with a second merchant;
receiving, by the server system, an acceptance of the collaboration from the second merchant; and
in response to receiving the acceptance of the collaboration from the second merchant, transmitting, by the server system, a second offer to the consumer computing device on behalf of the second merchant in response to the request to generate the offer.

7. The method of claim 6, further comprising:
processing, by the server system, payment of a fee by the second merchant in response to transmitting the second offer to the consumer computing device; and
crediting, by the server system, at least a portion of the fee to the first merchant.

8. The method of claim 1, wherein:
defining, by the server system, a plurality of offers, the offer being one of the plurality of offers, wherein defining the plurality of offers includes defining variation of offer parameters among the plurality of offers;
evaluating, by the server system, any redemption of offers of the plurality of offers by the consumer;
identifying, by the server system, a preferred set of offer parameters according to the evaluating of any redemption of the offers of the plurality of offers.

9. The method of claim 8, wherein the offer parameters include all of offer duration, offer benefit, and offer price.

10. The method of claim 8, further comprising presenting the plurality of offers to the consumer according to a search sequence, the search sequence including at least one of a monotonically increasing desirability, a monotonically decreasing desirability, and a binary search sequence.

11. A system comprising one or more processing devices and one or more memory devices operably coupled to the one or more processing devices, the one or more memory devices storing executable code effective to cause the one or more processing devices to:
receive a request to generate an offer for a consumer;
in response to receiving the request, generate an offer having a custom duration determined according to a transaction history of the consumer; and
transmit the offer to a consumer computing device corresponding to the consumer.

12. The system of claim 11, wherein the executable code is further effective to cause the one or more processing devices to receive the request to generate the offer by receiving the request to generate the offer from a merchant computing device, the offer being issued on behalf of a merchant associated with the merchant computing device.

13. The system of claim 11, wherein the executable code is further effective to cause the one or more processing devices to receive the request to generate the offer by receiving the request to generate the offer from the consumer computing device.

14. The system of claim 11, wherein the executable code is further effective to cause the one or more processing devices to:
receive, from one or more affiliate computer systems, assignment of points to the consumer; and
receive the request to generate the offer by receiving, from the consumer computing device, a request to purchase the offer using the points.

15. The system of claim 11, wherein the consumer is a first consumer; and
wherein the executable code is further effective to cause the one or more processing devices to:
receive, from the consumer computing device, a request to clone the offer; and
in response to receiving the request to clone the offer, add a copy of the offer to a mobile wallet of a second consumer.

16. The system of claim 11, wherein the offer is a first offer;
wherein the executable code is further effective to cause the one or more processing devices to:
receive a request from a first merchant to collaborate with a second merchant;
receiving, by the server system, an acceptance of the collaboration from the second merchant; and
in response to receiving the acceptance of the collaboration from the second merchant, transmitting, by the server system, a second offer to the consumer computing device on behalf of the second merchant in response to the request to generate the offer.

17. The system of claim 16, wherein the executable code is further effective to cause the one or more processing devices to:
process payment of a fee by the second merchant in response to transmitting the second offer to the consumer computing device; and
credit at least a portion of the fee to the first merchant.

18. The system of claim 11, wherein the executable code is further effective to cause the one or more processing devices to:
define a plurality of offers, the offer being one of the plurality of offers, wherein defining the plurality of offers includes defining variation of offer parameters among the plurality of offers;
evaluate any redemption of offers of the plurality of offers by the consumer;
identify a preferred set of offer parameters according to the evaluating of any redemption of the offers of the plurality of offers.

19. The system of claim 18, wherein the offer parameters include all of offer duration, offer benefit, and offer price.

20. The system of claim 18, wherein the executable code is further effective to cause the one or more processing devices to present the plurality of offers to the consumer according to a search sequence, the search sequence including at least one of a monotonically increasing desirability, a monotonically decreasing desirability, and a binary search sequence.
